(19) United States
(12) Patent Application Publication
(10) Pub. No.: US 2025/0370402 A1
(43) Pub. Date: Dec. 4, 2025

(54) IMAGE FORMING APPARATUS AND CARTRIDGE SET

(71) Applicant: CANON KABUSHIKI KAISHA, Tokyo (JP)

(72) Inventors: OSAMU NAGASAKI, Shizuoka (JP); TERUHIKO SASAKI, Shizuoka (JP); TAKANORI YAMAMOTO, Shizuoka (JP); NAOYA ASANUMA, Shizuoka (JP); AKINOBU HIRAYAMA, Shizuoka (JP)

(21) Appl. No.: 19/220,677

(22) Filed: May 28, 2025

(30) Foreign Application Priority Data
May 30, 2024 (JP) 2024-088069

(51) Int. Cl. G03G 21/16; G03G 15/08

(52) U.S. Cl. CPC G03G 21/1652; G03G 15/0863; G03G 15/0875; G03G 15/0886; G03G 15/0889; G03G 21/1647; G03G 2215/068; G03G 2215/0692; G03G 2215/0827; G03G 2221/1823

(57) ABSTRACT

An apparatus main body of an image forming apparatus has a first mounting portion for mounting a first toner cartridge, the first mounting portion having a first terminal that electrically contacts a first cartridge contact surface, and a second mounting portion for mounting a second toner cartridge, the second mounting portion having a second terminal that electrically contacts a second cartridge contact surface. When viewed in a direction parallel to a mounting direction, a first electric substrate has the same shape as a second electric substrate, and a first attachment portion has the same shape as a second attachment portion. An angle at which the first electric substrate is attached to the first attachment portion is different from an angle at which the second electric substrate is attached to the second attachment portion.

### BACKGROUND

### Field of the Technology

The present disclosure relates to an image forming apparatus that forms an image on a recording material.

### Description of the Related Art

Generally, in an electrophotographic image forming apparatus, a toner cartridge storing toner (developer), which is consumed during image formation, is detachably attached to an image forming apparatus main body in order to replenish toner. Furthermore, a configuration is known in which a storage medium is mounted on the toner cartridge, and the usage information, toner color, remaining toner amount, and the like of the toner cartridge are stored, and the toner cartridge communicates with the image forming apparatus main body to appropriately provide the user with information such as the replacement timing of the toner cartridge. Generally, the storage medium is mounted on a circuit substrate attached to the toner cartridge. The toner cartridge includes one or more electrical contacts that engage with corresponding electrical contacts in the image forming apparatus when the toner cartridge is mounted on the image forming apparatus in order to facilitate communication with the control portion of the image forming apparatus main body.

In a color image forming apparatus storing toners of different colors such as yellow, magenta, cyan, and black, a plurality of toner cartridges having substantially the same or nearly the same structure is used. A method has been proposed in which each toner cartridge has a key function or a shielding function that allows the user to mount the appropriate toner cartridge for each color in the corresponding mounting port of the image forming apparatus (Japanese Patent Application Publication No. 2008-134524). If a user attempts to mount a toner cartridge in the wrong mounting port, it cannot be mounted completely, and color mixing and contamination due to mounting a toner cartridge of the wrong color can be prevented.

### SUMMARY

The present disclosure is directed to provide the technology to develop the conventional configuration further.

To solve the above-mentioned problems, the image forming apparatus of the present disclosure for forming a toner image on a recording material includes the following:
an apparatus main body, the apparatus main body including a first photosensitive drum having a first direction as a longitudinal direction, a second photosensitive drum having the first direction as the longitudinal direction, a first developing unit having a first developing roller that supplies toner to the first photosensitive drum and a first toner storage portion that stores toner to be borne by the first developing roller, and a second developing unit having a second developing roller that supplies toner to the second photosensitive drum and a second toner storage portion that stores toner to be borne by the second developing roller;
a first toner cartridge for replenishing toner to the first developing unit, the first toner cartridge having a first container for storing toner, and being mountable in a mounting direction that is a direction along the first direction with respect to the apparatus main body; and
a second toner cartridge for replenishing toner to the second developing unit, the second toner cartridge having a second container for storing toner, and being mountable in the mounting direction with respect to the apparatus main body,
wherein the first toner cartridge has a first memory unit including a first electric substrate provided with a first cartridge contact surface and a first attachment portion to which the first electric substrate is attached,
wherein the second toner cartridge has a second memory unit including a second electric substrate provided with a second cartridge contact surface and a second attachment portion to which the second electric substrate is attached,
wherein the apparatus main body has a first mounting portion for mounting the first toner cartridge and a second mounting portion for mounting the second toner cartridge, the first mounting portion being provided with a first terminal that electrically contacts the first cartridge contact surface, and the second mounting portion being provided with a second terminal that electrically contacts the second cartridge contact surface, and
wherein, in a case of being viewed in a direction parallel to the mounting direction, the first electric substrate has the same shape as the second electric substrate, the first attachment portion has the same shape as the second attachment portion and an angle at which the first electric substrate is attached to the first attachment portion is different from an angle at which the second electric substrate is attached to the second attachment portion.

To solve the above-mentioned problems, the image forming apparatus of the present disclosure for forming a toner image on a recording material includes the following:
an apparatus main body, the apparatus main body including a first photosensitive drum having a first direction as a longitudinal direction, a second photosensitive drum having the first direction as the longitudinal direction, a first developing unit having a first developing roller that supplies toner to the first photosensitive drum and a first toner storage portion that stores toner to be borne by the first developing roller, and a second developing unit having a second developing roller that supplies toner to the second photosensitive drum and a second toner storage portion that stores toner to be borne by the second developing roller;
a first toner cartridge for replenishing toner to the first developing unit, the first toner cartridge having a first container for storing toner, and being mountable in a mounting direction that is a direction along the first direction with respect to the apparatus main body; and
a second toner cartridge for replenishing toner to the second developing unit, the second toner cartridge having a second container for storing toner, and being mountable in the mounting direction with respect to the apparatus main body,
wherein the first toner cartridge has a first memory unit including a first electric substrate on which a first cartridge contact surface is provided,
wherein the second toner cartridge has a second memory unit including a second electric substrate on which a second cartridge contact surface is provided,
wherein the apparatus main body has a first mounting portion for mounting the first toner cartridge and a second mounting portion for mounting the second toner cartridge, the first mounting portion being provided with a first terminal that electrically contacts the first cartridge contact surface, and the second mounting portion being provided with a second terminal that electrically contacts the second cartridge contact surface, and
wherein a normal direction of the first cartridge contact surface of the first electric substrate and a normal direction of the second cartridge contact surface of the second electric substrate both intersect the mounting direction and are different from each other.

To solve the above-mentioned problems, the image forming apparatus of the present disclosure for forming a toner image on a recording material includes the following:
an apparatus main body, the apparatus main body including a first photosensitive drum having a first direction as a longitudinal direction, a second photosensitive drum having the first direction as the longitudinal direction, a first developing unit having a first developing roller that supplies toner to the first photosensitive drum and a first toner storage portion that stores toner to be borne by the first developing roller, and a second developing unit having a second developing roller that supplies toner to the second photosensitive drum and a second toner storage portion that stores toner to be borne by the second developing roller;
a first toner cartridge for replenishing toner to the first developing unit, the first toner cartridge having a first container for storing toner, and being mountable in a mounting direction that is a direction along the first direction with respect to the apparatus main body; and
a second toner cartridge for replenishing toner to the second developing unit, the second toner cartridge having a second container for storing toner, and being mountable in the mounting direction with respect to the apparatus main body,
wherein the first toner cartridge has a first memory unit including a first electric substrate on which a plurality of first cartridge contact surfaces is provided and a normal direction of the first cartridge contact surfaces is the mounting direction,
wherein the second toner cartridge has a second memory unit including a second electric substrate on which a plurality of second cartridge contact surfaces is provided and a normal direction of the second cartridge contact surfaces is the mounting direction,
wherein the apparatus main body has a first mounting portion for mounting the first toner cartridge and a second mounting portion for mounting the second toner cartridge, the first mounting portion being provided with a first terminal that electrically contacts the first cartridge contact surfaces, and the second mounting portion being provided with a second terminal that electrically contacts the second cartridge contact surfaces, and
wherein, in a case of being viewed in a direction parallel to the mounting direction, a direction in which the plurality of the first cartridge contact surfaces is aligned is different from a direction in which the plurality of the second cartridge contact surfaces is aligned.

To solve the above-mentioned problems, the image forming apparatus of the present disclosure for forming a toner image on a recording material includes the following:
an apparatus main body, the apparatus main body including a first photosensitive drum having a first direction as a longitudinal direction, a second photosensitive drum having the first direction as the longitudinal direction, a first developing unit having a first developing roller that supplies toner to the first photosensitive drum and a first toner storage portion that stores toner to be borne by the first developing roller, and a second developing unit having a second developing roller that supplies toner to the second photosensitive drum and a second toner storage portion that stores toner to be borne by the second developing roller;
a first toner cartridge for replenishing toner to the first developing unit, the first toner cartridge having a first container for storing toner, and being mountable in a mounting direction that is a direction along the first direction with respect to the apparatus main body; and
a second toner cartridge for replenishing toner to the second developing unit, the second toner cartridge having a second container for storing toner, and being mountable in the mounting direction with respect to the apparatus main body,
wherein the first toner cartridge has a first memory unit including a first electric substrate provided with a first cartridge contact surface, a first agitation member for agitating the toner inside of the first container, and a first driving force receiving member for receiving a driving force for driving the first agitation member, the first driving force receiving member rotating around a first rotation axis extending in the mounting direction,
wherein the second toner cartridge has a second memory unit including a second electric substrate provided with a second cartridge contact surface, a second agitation member for agitating the toner inside of the second container, and a second driving force receiving member for receiving a driving force for driving the second agitation member, the second driving force receiving member rotating around a second rotation axis extending in the mounting direction,
wherein the apparatus main body has a first mounting portion for mounting the first toner cartridge, a second mounting portion for mounting the second toner cartridge, a first driving member that engages with the first driving force receiving member to transmit a driving force to the first driving force receiving member, and a second driving member that engages with the second driving force receiving member to transmit a driving force to the second driving force receiving member, the first mounting portion being provided with a first terminal that electrically contacts the first cartridge contact surface, and the second mounting portion being provided with a second terminal that electrically contacts the second cartridge contact surface, and
wherein, in a case of being viewed in a direction parallel to the mounting direction, coordinates of the first electric substrate in a two-dimensional first coordinate system composed of a first virtual line that passes through the first rotation axis as its origin and extends in a horizontal direction, and a second virtual line that passes through the first rotation axis and extends in a gravitational direction, and coordinates of the second electric substrate in a two-dimensional second coordinate system composed of a third virtual line that passes through the second rotation axis as its origin and extends in the horizontal direction, and a fourth virtual line that passes through the second rotation axis and extends in the gravitational direction, have different regions in a case where the first coordinate system and the second coordinate system are superimposed so that their respective origins coincide.

To solve the above-mentioned problems, the cartridge set of the present disclosure includes the following:
a first toner cartridge; and
a second toner cartridge;
the first toner cartridge includes:
   a first container for storing a first toner, the first container having a first direction as a longitudinal direction, and having a first discharge port that opens in a direction intersecting the first direction so as to discharge the first toner from the first container; and
   a first memory unit provided on a first attachment portion on an end surface of the first container in the first direction, the first memory unit including a first electric substrate having a first cartridge contact surface,
the second toner cartridge includes:
   a second container for storing a second toner having a color different from that of the first toner, the second container having a second direction as a longitudinal direction, and having a second discharge port that opens in a direction intersecting the second direction so as to discharge the second toner from the second container; and
   a second memory unit provided on a second attachment portion on an end surface of the second container in the second direction, the second memory unit including a second electric substrate having a second cartridge contact surface,
wherein the first attachment portion and the first electric substrate in a case of being viewed in the first direction have the same shape as the second attachment portion and the second electric substrate in a case of being viewed in the second direction, and
wherein an attachment angle of the first electric substrate relative to the first attachment portion in a case of being viewed in the first direction is different from an attachment angle of the second electric substrate relative to the second attachment portion in a case of being viewed in the second direction.

To solve the above-mentioned problems, the cartridge set of the present disclosure includes the following:
a first toner cartridge detachably attached to an apparatus main body of an image forming apparatus; and
a second toner cartridge detachably attached to the apparatus main body;
the first toner cartridge includes:
   a first container for storing a first toner, the first container having a first direction as a longitudinal direction, and having a first discharge port that opens in a direction intersecting the first direction so as to discharge the first toner from the first container; and
   a first memory unit provided on a first end surface which is an end surface of the first container in the first direction and including a first electric substrate on which a first cartridge contact surface is provided;
the second toner cartridge includes:
   a second container for storing a second toner having a color different from that of the first toner, the second container having a second direction as a longitudinal direction, and having a second discharge port that opens in a direction intersecting the second direction so as to discharge the second toner from the second container; and
   a second memory unit provided on a second end surface which is an end surface of the second container in the second direction and including a second electric substrate on which a second cartridge contact surface is provided,
wherein, in a state where the first toner cartridge and the second toner cartridge are mounted in the apparatus main body such that the first direction and the second direction are parallel, a normal direction of the first cartridge contact surface of the first electric substrate and a normal direction of the second cartridge contact surface of the second electric substrate both intersect the first direction and the second direction and are different from each other.

To solve the above-mentioned problems, the cartridge set of the present disclosure includes the following:
a first toner cartridge detachably attached to an apparatus main body of an image forming apparatus; and
a second toner cartridge detachably attached to the apparatus main body;
the first toner cartridge includes:
   a first container for storing a first toner, the first container having a first direction as a longitudinal direction, and having a first discharge port that opens in a direction intersecting the first direction so as to discharge the first toner from the first container; and
   a first memory unit provided on a first end surface which is an end surface of the first container in the first direction and including a first electric substrate on which a plurality of first cartridge contact surfaces is provided;
the second toner cartridge includes:
   a second container for storing a second toner having a color different from that of the first toner, the second container having the second direction as a longitudinal direction and having a second discharge port that opens in a direction intersecting the second direction so as to discharge the second toner from the second container; and
   a second memory unit provided on a second end surface which is an end surface of the second container in the second direction and having a second electric substrate on which a plurality of second cartridge contact surfaces is provided,
wherein, in a state where the first toner cartridge and the second toner cartridge are mounted in the apparatus main body such that the first direction and the second direction are parallel, a direction in which the plurality of the first cartridge contact surfaces is aligned in a case of being viewed in the first direction is different from a direction in which the plurality of the second cartridge contact surfaces is aligned in a case of being viewed in the second direction.

To solve the above-mentioned problems, the cartridge set of the present disclosure includes the following:
a first toner cartridge detachably attached to an apparatus main body of an image forming apparatus; and
a second toner cartridge detachably attached to the apparatus main body;
the first toner cartridge includes:
   a first container for storing a first toner, the first container having a first direction as a longitudinal direction, and having a first discharge port that opens in a direction intersecting the first direction so as to discharge the first toner from the first container;
   a first memory unit provided on a first end surface which is an end surface of the first container in the first direction and including a first electric substrate on which a first cartridge contact surface is provided; and
   a first agitation member for agitating toner inside of the first container; and a first driving force receiving member for receiving a driving force for driving the first agitation member, the first driving force receiving member rotating around a first rotation axis extending in the first direction,
the second toner cartridge includes:
   a second container for storing a second toner having a color different from that of the first toner, the second container having the second direction as a longitudinal direction and having a second discharge port that opens in a direction intersecting the second direction and for discharging the second toner from the second container;
   a second memory unit provided on a second end surface which is an end surface of the second container in the second direction and including a second electric substrate on which a second cartridge contact surface is provided; and
   a second agitation member for agitating toner inside of the second container; and a second driving force receiving member for receiving a driving force for driving the second agitation member, the second driving force receiving member rotating around a second rotation axis extending in the second direction;
wherein, in a state where the first toner cartridge and the second toner cartridge are mounted in the apparatus main body so that the first direction and the second direction are parallel,
wherein coordinates of the first electric substrate in a two-dimensional first coordinate system composed of a first virtual line that passes through the first rotation axis as its origin and extends in a horizontal direction, and a second virtual line that passes through the first rotation axis and extends in a gravitational direction in a case of being viewed in the first direction, and coordinates of the second electric substrate in a two-dimensional second coordinate system composed of a third virtual line that passes through the second rotation axis as its origin and extends in the horizontal direction, and a fourth virtual line that passes through the second rotation axis and extends in the gravitational direction in a case of being viewed in the second direction have different regions in a case where the first coordinate system and the second coordinate system are superimposed so that their respective origins coincide.

Further features of the present disclosure will become apparent from the following description of embodiments with reference to the attached drawings. The following description of embodiments are described by way of example.

### BRIEF DESCRIPTION OF THE DRAWINGS

FIG. 1 is a schematic cross-sectional view showing an image forming apparatus.

FIG. 2 is a perspective view showing an image forming apparatus according to the first embodiment.

FIG. 3 is a perspective view of the toner cartridge from the front.

FIGS. 4A and 4B are perspective views of the toner cartridge from the rear.

FIG. 5 is a cross-sectional view of a toner conveying device.

FIGS. 6A to 6D are overall views of a memory tag substrate.

FIGS. 7A to 7C are overall views of a substrate holder.

FIG. 8 is an overall view of a memory tag unit.

FIG. 9 is an overall view of a memory tag cover.

FIGS. 10A and 10B are a perspective view of the toner cartridge from the rear and an enlarged view of a memory tag space.

FIGS. 11A and 11B are perspective views of the memory tag unit and the memory tag cover mounted in the memory tag space.

FIG. 12 is a perspective view of a toner cartridge mounting portion.

FIGS. 13A to 13D are a front view of the toner cartridges of each color from the rear, a front view of the toner cartridge mounting portion from the front, and enlarged views.

FIGS. 14A to 14C are a cross-sectional view showing the cross-section of the toner cartridge and the toner cartridge mounting portion and an enlarged view of the vicinity of the memory tag.

FIGS. 15A to 15C are enlarged views of the vicinity of the electrical contacts to explain the floating structure.

FIG. 16 is a perspective view showing an image forming apparatus according to a second embodiment.

FIG. 17 is a perspective view showing a toner cartridge from the front.

FIGS. 18A and 18B are perspective views showing a toner cartridge from the rear.

FIG. 19 is an overall view showing a memory tag substrate.

FIGS. 20A and 20B are perspective views showing a state in which the memory tag substrate is attached to the substrate holder.

FIGS. 21A and 21B are a perspective view showing a toner cartridge from the rear and an enlarged view showing a memory tag space.

FIGS. 22A and 22B are perspective views showing a state in which a memory tag unit and a memory tag cover are mounted in the memory tag space.

FIGS. 23A to 23D are a front view showing a toner cartridge of each color from the rear, a front view showing a toner cartridge mounting portion from the front, and enlarged views.

FIGS. 24A to 24C are a cross-sectional view showing a cross-section of a toner cartridge and a toner cartridge mounting portion and an enlarged view of the vicinity of the memory tag.

FIGS. 25A to 25C are enlarged views of the vicinity of an electrical contact to explain a floating structure. and

FIG. 26 is a diagram explaining the difference in the arrangement of memory tags for each toner cartridge.

### DESCRIPTION OF THE EMBODIMENTS

Hereinafter, embodiments for performing the present disclosure will be described in detail as examples on the basis of examples with reference to the drawings. However, the dimensions, materials, shapes, relative arrangements, and the like of the components described in the embodiments may be appropriately modified according to the configurations or various conditions of the apparatus to which the disclosure is applied. In other words, the scope of the disclosure is not intended to be limited to the following embodiments. While a plurality of features is described in the respective embodiments, all of the plurality of features are not necessarily essential to the disclosure, and the plurality of features may be combined arbitrarily with each other. Moreover, in the accompanying drawings, the same reference numeral will be assigned to the same or similar component, and overlapping descriptions will be omitted.

### First Embodiment

### Configuration of Image Forming Apparatus

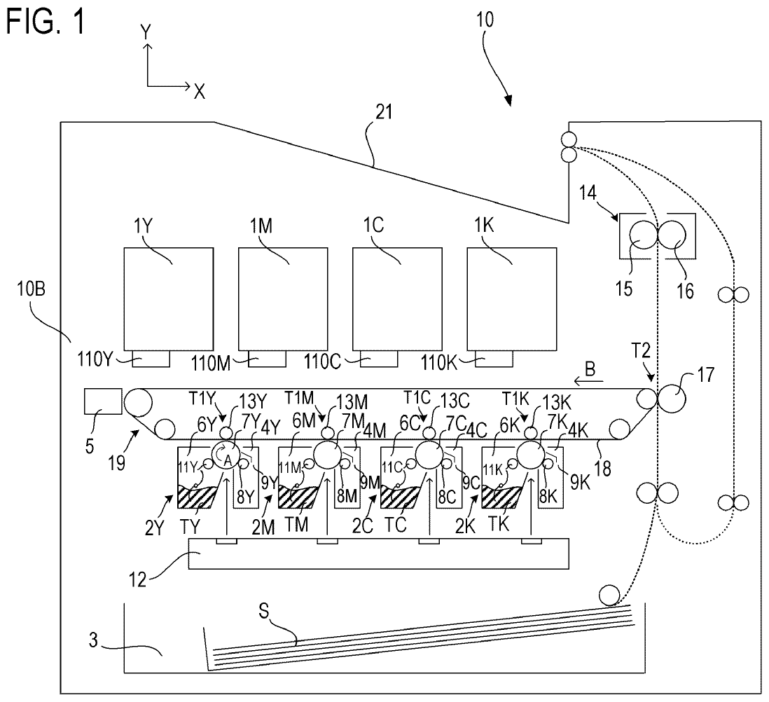

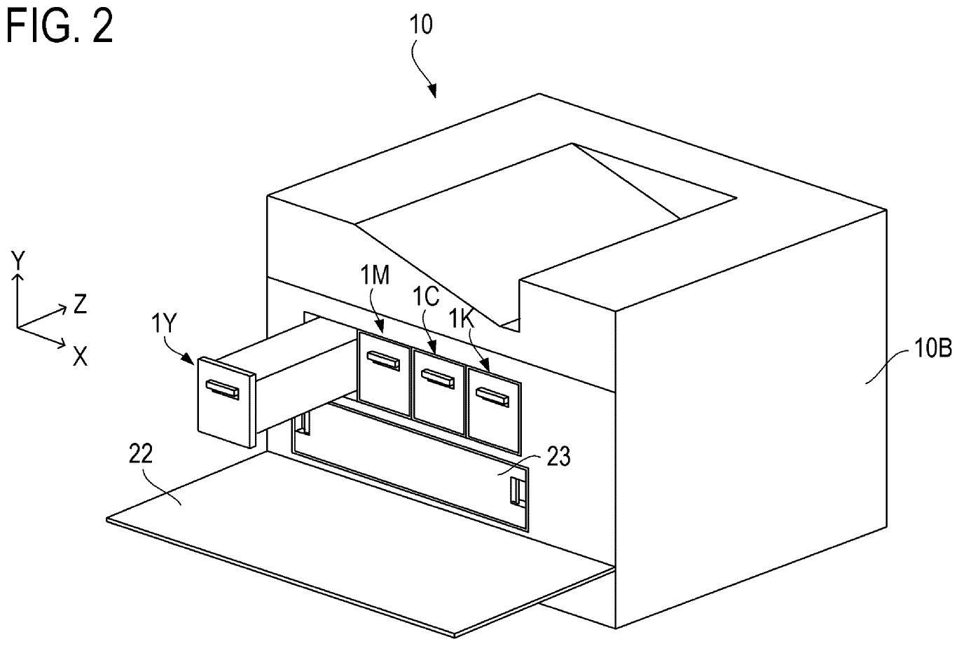

The overall configuration of an image forming apparatus according to the first embodiment of the present disclosure will be described with reference to FIGS. 1 and 2. FIG. 1 is a schematic diagram showing an image forming apparatus 10, which is an electrophotographic printer according to the first embodiment. In the present embodiment, the toner cartridge 1 and the process cartridge 2 are detachably attached to an apparatus main body 10B of the image forming apparatus 10.

Note that the portion of the image forming apparatus 10, excluding a toner cartridge 1 and a process cartridge 2, may be referred to as the main body of the image forming apparatus 10 or the apparatus main body 10B. The apparatus main body 10B is configured to receive the toner discharged from the toner cartridge 1.

In each drawing, in order to distinguish the configurations of the first to fourth image forming portions, the suffixes Y, M, C, and K are added to the end of the reference numerals attached to each part of the image forming portion, indicating the difference in the color of the toner, that is, yellow (Y), magenta (M), cyan (C), and black (K). In the present embodiment, the configurations and operations of the first to fourth image forming portions are substantially the same except for the difference in the color of the image they form. Therefore, unless the image forming portions need to be particularly distinguished from each other in the following description, the image forming portions will be generally described by omitting the suffixes Y to K.

The image forming apparatus 10 according to the present embodiment is placed on a horizontal mounting surface as a normally assumed mounting state. The X and Z directions in the figure are parallel to the horizontal direction, and the Y direction is the vertical direction (gravitational direction). The X, Y, and Z directions are orthogonal to each other.

The first to fourth process cartridges 2 are arranged in the horizontal direction, more specifically, in the X direction. Each process cartridge 2 is formed of a cleaning unit 4 and a developing unit 6. The cleaning unit 4 has a photosensitive drum 7 as an image bearing member, a charging roller 8 as a charging member for uniformly charging the surface of the photosensitive drum 7, and a cleaning blade 9 as a cleaning member. The developing unit 6 has a developing roller 11 as a developer bearing member that bears a developer (hereinafter, toner) T, and a developing portion that has a toner storage portion that stores the toner T and develops an electrostatic latent image on the photosensitive drum 7. The cleaning unit 4 and the developing unit 6 are supported so as to be able to swing relative to each other.

The first process cartridge 2Y stores yellow (Y) toner in the developing unit 6. Similarly, the second process cartridge 2M stores magenta (M) toner, the third process cartridge 2C stores cyan (C) toner, and the fourth process cartridge 2K stores black (K) toner.

The process cartridge 2 is detachably attached to the main body of the image forming apparatus 10 via mounting means such as a mounting guide (not shown) and a positioning member (not shown) provided in the main body of the image forming apparatus 10. A scanner unit 12 for forming an electrostatic latent image is disposed below the process cartridge 2. Furthermore, a waste toner conveying unit is disposed behind the process cartridge 2 in the image forming apparatus 10 (downstream of the process cartridge 2 in the insertion direction of the process cartridge 2 (rearward in the Z direction)). The first to fourth toner cartridges 1 are arranged as a cartridge set in a horizontal direction (X direction) above the process cartridge 2 in the order corresponding to the color of the toner stored in each process cartridge 2 (with their respective longitudinal directions parallel to each other).

The first toner cartridge 1Y stores yellow (Y) toner, and similarly, the second toner cartridge 1M stores magenta (M), the third toner cartridge 1C stores cyan (C), and the fourth toner cartridge 1K stores black (K). Each toner cartridge 1 replenishes toner to the process cartridge 2 that stores the same color toner. The toner replenishment operation (supply operation) by the toner cartridge 1 is performed when a remaining amount detection unit (not shown) provided in the apparatus main body 10B of the image forming apparatus 10 detects a shortage of toner remaining in the process cartridge 2.

Inside of the main body of the image forming apparatus 10, first to fourth toner conveying devices 110 are arranged below the first to fourth toner cartridges 1 so as to correspond to the respective toner cartridges 1. Above the process cartridge 2, an intermediate transfer unit 19 is provided as an intermediate transfer body. The intermediate transfer unit 19 is arranged substantially in a horizontal direction with the primary transfer portion side facing downward. An intermediate transfer belt 18 facing each photosensitive drum 7 is a rotatable endless belt, and is stretched around a number of tension rollers. On the inner surface of the intermediate transfer belt 18, primary transfer rollers 13 as primary transfer members are arranged at positions where they form a primary transfer portion T1 with each photosensitive drum 7 via the intermediate transfer belt 18. Furthermore, the secondary transfer roller 17 as a secondary transfer member contacts the intermediate transfer belt 18, and forms a secondary transfer portion T2 with the opposing roller via the intermediate transfer belt 18.

Furthermore, a cleaning unit 5 is disposed on the opposite side of the intermediate transfer belt 18 from the secondary transfer portion T2 in the horizontal direction (X). A fixing unit 14 is disposed above the secondary transfer portion. The fixing unit 14 is composed of a heating unit 15 and a pressure roller 16 that is in pressure contact with the heating unit 15. Furthermore, a discharge tray 21 is disposed on the upper surface of the apparatus main body 10B. A paper feed tray 3 for storing recording material S is disposed at the bottom of the apparatus main body 10B.

As shown in FIG. 2, when the front cover 22 covering the front surface of the image forming apparatus 10 is opened, the toner cartridge 1 can be attached and detached via a mounting means such as a mounting guide (not shown) and a positioning member (not shown) provided on the main body of the image forming apparatus 10. The toner cartridge 1 is detachable (attachable) in the Z direction relative to the apparatus main body 10B. The mounting direction of the toner cartridge 1 relative to the apparatus main body 10B is along the longitudinal direction (first direction) of the photosensitive drum 7. Furthermore, a waste toner collecting container 23 is disposed below the toner cartridge 1. The waste toner collecting container 23 is located on the front side (the front side in the Z direction) of the process cartridge 2 shown in FIG. 1. The waste toner collecting container 23 is configured to collect the waste toner collected by the cleaning unit 4 provided in the process cartridge 2 and the cleaning unit 5 provided adjacent to the intermediate transfer unit 19.

In FIG. 2, the first toner cartridge 1Y is shown in a removable state, and the second to fourth toner cartridges 1M to 1K are shown in a mounted state in the apparatus main body 10B. The front part of the first toner cartridge 1Y, which is in a removable state, is located in a position protruding forward in the Z direction from the front parts of the other mounted toner cartridges 1M to 1K and the waste toner collecting container 23.

### Image Forming Process

With reference to FIGS. 1 and 2, the image forming operation in the image forming apparatus 10 will be described. During image formation, the photosensitive drum 7 is rotated at a predetermined speed in the direction of arrow A in FIG. 1. The intermediate transfer belt 18 is rotated in the direction of arrow B (the forward direction of the rotation of the photosensitive drum 7).

First, the surface of the photosensitive drum 7 is uniformly charged by the charging roller 8. Next, the surface of the photosensitive drum 7 is scanned and exposed by a laser beam emitted from the scanner unit 12, and an electrostatic latent image based on the image information is formed on the photosensitive drum 7. The electrostatic latent image formed on the photosensitive drum 7 is developed into a toner image by the developing unit 6. At this time, the developing unit 6 is pressurized by a developing pressure unit (not shown) provided in the apparatus main body 10B. The toner image formed on the photosensitive drum 7 is then primarily transferred onto the intermediate transfer belt 18 by the primary transfer roller 13. For example, when a full-color image is formed, the above-mentioned processes are sequentially performed in the image forming portions TY to TK, which are the first to fourth primary transfer portions, and the toner images of each color are sequentially superimposed on the intermediate transfer belt 18.

Meanwhile, the recording material S stored in the paper feed tray 3 is fed at a predetermined control timing and conveyed to the secondary transfer portion T2 in synchronization with the movement of the intermediate transfer belt 18. Then, the four-color toner image on the intermediate transfer belt 18 is secondarily transferred onto the recording material S at once by the secondary transfer roller 17, which is in contact with the intermediate transfer belt 18 via the recording material S. Then, the recording material S onto which the toner image has been transferred is conveyed to the fixing unit 14. The recording material S is heated and pressurized in the fixing unit 14 so that the toner image is fixed onto the recording material S. Then, the recording material S onto which the toner image has been fixed is conveyed to the discharge tray 21 so that the image forming operation is completed.

The primary transfer residual toner (waste toner) remaining on the photosensitive drum 7 after the primary transfer process is removed by the cleaning blade 9. The secondary transfer residual toner (waste toner) remaining on the intermediate transfer belt 18 after the secondary transfer process is removed by the cleaning unit 5. The waste toner removed by the cleaning blade 9 and the cleaning unit 5 is conveyed by a waste toner conveying unit (not shown) provided in the apparatus main body 10B, and is accumulated in the waste toner collecting container 23. The image forming apparatus 10 can also form a single-color or multi-color image by using only a desired single or several (not all) image forming portions.

### Overall Configuration of Toner Cartridge

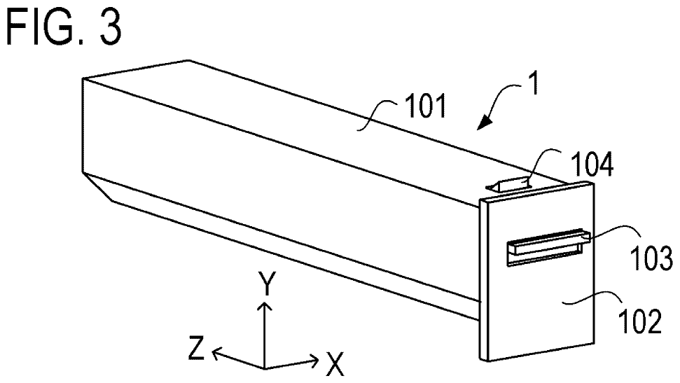

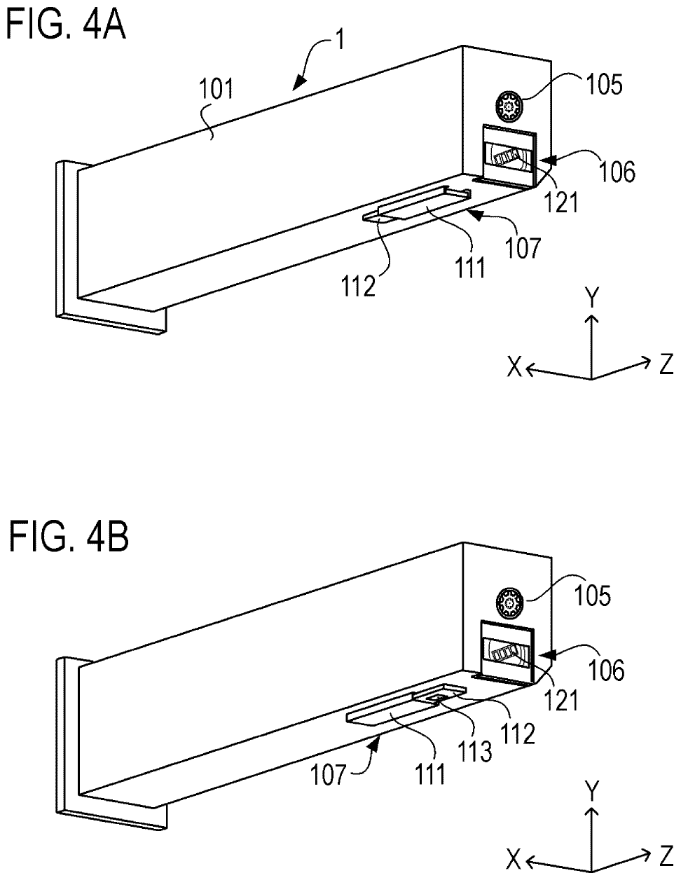

The overall configuration of the toner cartridge 1 to be mounted in the image forming apparatus 10 according to the present embodiment will be described with reference to FIGS. 3, 4A, and 4B.

### Explanation of XYZ Directions

When describing the image forming apparatus 10 and the toner cartridge 1, unless otherwise specified, the directions are defined as follows, assuming that the toner cartridge 1 is in a normal posture, that is, the posture when mounted inside of the apparatus main body 10B.

The up-down direction is indicated by the Y axis. Arrow Y indicates the upward direction. The surface provided at the end in the Y direction is referred to as the top surface (upper surface), and conversely, the surface provided at the end in the −Y direction is referred to as the bottom surface (bottom, lower part, lower end). The Y direction and the −Y direction may be collectively referred to as the up-down direction, height direction, vertical direction, gravitational direction, or Y-axis direction.

The front-rear direction is indicated by the Z axis. In the mounting direction, when the toner cartridge 1 is mounted in the main body of the image forming apparatus 10, the direction toward the downstream side is indicated by arrow Z, and the direction toward the downstream side of the mounting direction is referred to as the Z direction. For convenience, the Z direction is referred to as the rear, and the −Z direction is referred to as the front. The surface provided at the end in the Z direction is referred to as the rear surface (back surface, rear end, rear part), and the surface provided at the end in the −Z direction is referred to as the front surface (front part, front end). In addition, the Z direction side of the toner cartridge 1 may be referred to as the driving side, and the −Z direction side of the toner cartridge 1 may be referred to as the non-driving side. The spread from the front surface to the rear surface (spread in the Z-axis direction) is referred to as the longitudinal direction. The Z direction and the −Z direction may be collectively referred to as the front-rear direction, longitudinal direction, vertical direction, Z direction, or Z-axis direction.

The left-right direction is indicated by the X axis. For convenience, the direction to the right when the image forming apparatus 10 is viewed from the front in the Z direction is indicated by arrow X. The surface provided at the end in the X direction is referred to as the right side (right surface, right end, right part), and the surface provided at the end in the −X direction is referred to as the left side (left surface, left part, left end). The direction from the left side to the right side (that is, the spread of the X axis) is the lateral direction. The X direction and the −X direction may be collectively referred to as the left-right direction, lateral direction, horizontal direction, X direction, or X-axis direction.

In the figures used to explain the present embodiment, the distance between the front and rear surfaces of the toner cartridge 1 is longer than the distance between the right side and the left side, and also longer than the distance between the upper surface and the bottom surface. However, the present disclosure is not limited to this configuration. For example, the distance between the right side and the left side of the toner cartridge 1 may be the longest, or the distance between the upper surface and the bottom surface may be the longest.

The X-axis, Y-axis, and Z-axis are perpendicular to each other. For example, the X-axis is perpendicular to the Y-axis and also perpendicular to the Z-axis. A plane perpendicular to the X-axis is sometimes referred to as the YZ plane, a plane perpendicular to the Y-axis is sometimes referred to as the ZX plane, and a plane perpendicular to the Z-axis is sometimes referred to as the XY plane. For example, the ZX plane is a horizontal plane. The X and Z directions are directions along the horizontal ZX plane, that is, horizontal directions.

FIG. 3 is a perspective view of the toner cartridge 1 as seen from the upper front side. The toner cartridge 1 is a container that stores toner (developer) in its internal space, and is mounted to the apparatus main body 10B of the image forming apparatus 10 (see FIG. 2) in order to supply (replenish) the toner to the apparatus main body 10B. The toner replenished to the apparatus main body 10B of the image forming apparatus 10 by the toner cartridge 1 is replenished to the process cartridge 2 by the toner conveying device 110 (see FIG. 1) as described above. That is, the toner cartridge 1 stores toner to be supplied (replenished) to the process cartridge 2.

As shown in FIG. 3, the toner cartridge 1 has a replenishment container 101 as a casing, and a front cover 102 on the surface that is disposed in front when the toner cartridge 1 is mounted in the apparatus main body 10B. Furthermore, the front cover 102 has a handle 103 that also serves as a lever for operating a locking mechanism when removing the toner cartridge 1 mounted in the apparatus main body 10B. When the handle 103 is pressed down in the −Y direction, a locking member 104 is lowered in the −Y direction, as described below.

FIGS. 4A and 4B are perspective views of the toner cartridge 1 as seen from the lower rear side. FIG. 4A shows the toner cartridge 1 when it is mounted to the image forming apparatus 100 and the toner can be discharged, and FIG. 4B shows the toner cartridge 1 when it is not mounted to the image forming apparatus 10 and the toner cannot be discharged. A coupling 105 (driving force receiving part) is provided on the rear surface of the toner cartridge 1 to connect with a drive transmission part arranged in the apparatus main body 10B and transmit power to a drive train (not shown) inside of the toner cartridge. Details of the apparatus main body 10B and the drive configuration inside of the toner cartridge 1 will be described later. A toner discharge portion 107 is provided on the bottom surface of the toner cartridge 1 to connect to a toner conveying device 110 (see FIG. 1) corresponding to each toner cartridge 1 when the toner cartridge 1 is mounted in the apparatus main body 10B and replenish toner.

The toner discharge portion 107 is provided with a shutter member 111 and a shutter guide 112 that guides the movement of the shutter member 111 in the Z direction. Furthermore, as shown in FIG. 4B, a discharge port 113 is provided in a part of the shutter guide 112 through which the toner is discharged downward (−Y direction) when the toner is discharged. When the toner cartridge 1 is mounted to the image forming apparatus 100, the shutter member 111 is pressed by a pressing portion (not shown) provided on the image forming apparatus 100. In this way, the shutter member 111 is moved from the blocking position to the open position against the biasing force of a shutter spring (not shown).

When the toner cartridge 1 is not mounted to the image forming apparatus 100, the shutter member 111 is positioned at the blocking position by the biasing force of the shutter spring (not shown). At this time, the shutter member 111 blocks the discharge port 113 formed on the bottom surface of the replenishment container 101 and restricts the discharge of toner from the toner cartridge 1. That is, when the shutter member 111 is in the blocking position, the shutter member 111 is arranged to overlap the discharge port 113 in a bottom view.

Here, the shutter member 111 in the present embodiment is configured to have no opening, but it may have an opening in a part of the shutter member 111. When the shutter member 111 is in the open position, the opening and the discharge port 113 may overlap so that toner can be discharged. The shutter member 111 itself is not essential. However, toner may be prevented from scattering from the discharge port 113 when the toner cartridge 1 is attached to or detached from the apparatus main body 10B or the toner cartridge 1 is removed from the apparatus main body 10B. From this perspective, it is desirable for the toner cartridge 1 to have the shutter member 111 to close the discharge port 113.

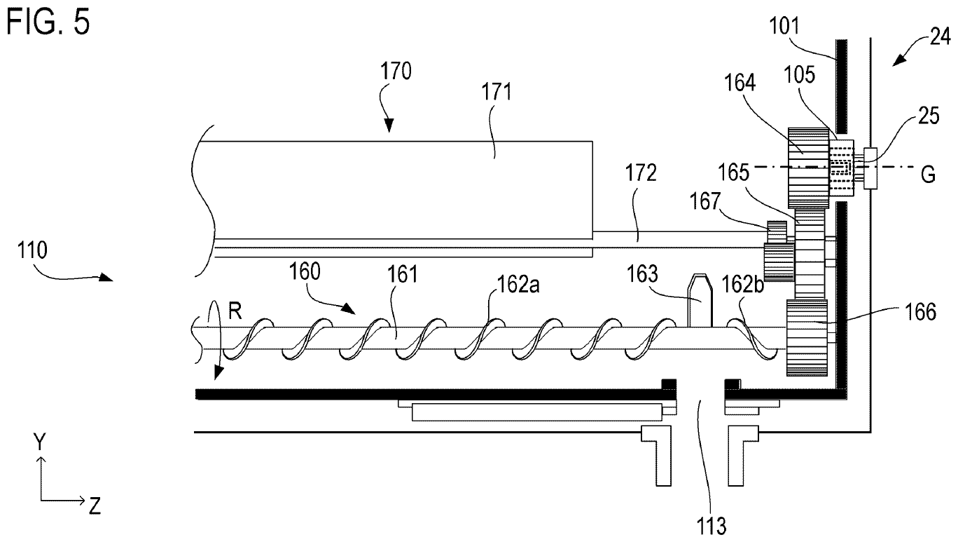

The toner conveying device 110 in the toner cartridge 1 will be described with reference to FIG. 5. FIG. 5 is a cross-sectional view showing a part of the configuration of the toner conveying device 110 inside of the toner cartridge 1.

The toner cartridge 1 is mounted in the toner cartridge mounting portion 24 of the apparatus main body 10B. At this time, the coupling 105 (driving force receiving portion, driving force receiving member) of the toner cartridge 1 is connected to the body-side coupling (driving force applying member, driving shaft, driving member) provided in the toner cartridge mounting portion 24. The coupling 105 rotates around the rotation axis G. The gear 164 linked to the coupling 105 drives multiple units within the toner cartridge 1 via the gear 165.

The toner cartridge 1 has a screw unit 160 as a conveying member and an agitation unit 170 as an agitation member in the internal space of the replenishment container 101. As shown in FIG. 5, the screw unit 160 has a screw 161 and a discharge sheet 163 fixed to the screw 161. The screw 161 extends in the Z direction. The internal space of the replenishment container 101 is divided into multiple areas, such as a toner storage chamber and a toner discharge chamber, which are not shown. The toner discharge chamber is provided with a discharge port 113 opening in a direction intersecting (orthogonal in the present embodiment, though not limited thereto) the mounting direction of the toner cartridge 1 relative to the apparatus main body 10B.

The discharge sheet 163 rotates in the R direction around a rotation axis (not shown) together with the screw 161 linked to the gear 166 and has the function of forcefully discharging the toner in the toner discharge chamber to the outside of the toner cartridge 1 through the discharge port 113. The agitation unit 170 has an agitation shaft 172 rotatably supported by the replenishment container 101 and an agitation sheet 171 fixed to the agitation shaft 172. The agitation shaft 172 extends in the Z direction. The agitation unit 170 rotates in conjunction with the gear 167 to agitate the toner stored in the toner storage chamber (not shown) and convey the toner toward the screw 161. The screw 161 has a first blade portion 162a and a second blade portion 162b formed integrally with the rotation shaft. The first blade portion 162a and the second blade portion 162b are each provided so as to extend in a spiral shape on the outer circumferential surface of the rotation shaft. The first blade portion 162a conveys the toner in the Z direction from the front surface to the rear surface of the toner cartridge 1. The second blade portion 162b conveys the toner in the −Z direction from the rear surface to the front surface of the toner cartridge 1. The toner conveyed within the toner discharge chamber by the first blade portion 162a of the screw 161 is forcefully discharged from the discharge port 113 to the outside of the toner cartridge 1 by the discharge sheet 163.

### Explanation of Memory Tag

As shown in FIGS. 4A and 4B, the memory tag 106 is disposed on the rear surface (end surface in the mounting direction) of the toner cartridge 1 between the coupling 105 and the toner discharge portion 107 in the Z direction of the toner cartridge 1. The memory tag 106, which serves as a storage portion (memory unit), stores information about the toner cartridge 1, such as information about whether the toner cartridge 1 is used or unused and the amount of toner remaining in the toner cartridge 1. When the toner cartridge 1 is mounted in the apparatus main body 10B, the electrical contacts 121 (cartridge-side contacts) of the memory tag 106 and the electrical contacts (hereinafter referred to as body-side contacts to distinguish them from the cartridge-side contacts) of the apparatus main body 10B come into electrical contact.

The position of the memory tag 106 in the Z direction does not have to be between the coupling 105 and the toner discharge portion 107. When arranging the memory tag 106 near the toner discharge portion 107, the memory tag 106 may be arranged in an orientation that is less susceptible to the effects of inadvertently scattered toner or to provided protective shielding since such toner may adversely affect electrical contact. In addition, the memory tag 106 may be avoided arranging near the above-mentioned waste toner collecting container 23 or the waste toner conveying unit (not shown) because there is a high risk that waste toner contamination may affect the electrical contact.

The electrical contacts 121 and the body-side contacts are each provided in multiple numbers, and in the present embodiment, each has four electrical contacts. The four electrical contacts include an electrical contact (VCC) 121-1, an electrical contact (CLK) 121-2, an electrical contact (DATA) 121-3, and an electrical contact (GND) 121-4, which are arranged in this order in a direction intersecting the direction along the mounting direction of the toner cartridge 1. The electrical contact (VCC) 121-1 is an electrical contact for transmitting a power supply voltage to the memory tag 106. The electrical contact (CLK) 121-2 is an electrical contact for transmitting a clock signal to the memory tag 106. The electrical contact (DATA) 121-3 is an electrical contact for transmitting data of the memory tag 106. The electrical contact (GND) 121-4 is an electrical contact for grounding the memory tag 106. In the following description, the electrical contact (VCC) 121-1, electrical contact (CLK) 121-2, electrical contact (DATA) 121-3, and electrical contact (GND) 121-4 are collectively referred to as electrical contacts 121. In the present embodiment, the configuration has four types of electrical contacts, but it may have two or more electrical contacts using different communication methods.

The control portion (not shown) of the image forming apparatus 10 supplies power and communicates via the electrical contacts to read information about the toner cartridge 1 stored in the memory tag 106. Details regarding the power supply and communication between the memory tag 106 and the control portion of the image forming apparatus 10 are omitted in the description of the present embodiment.

When the toner cartridge 1 is mounted in the apparatus main body 10B, the coupling 105 is connected to the body-side coupling (driving force applying member, driving shaft) of the apparatus main body 10B. Therefore, vibrations may occur when the toner cartridge 1 is mounted in the apparatus main body 10B, or when driving force is transmitted to the toner cartridge 1 via the coupling 105 while mounted in the apparatus main body 10B. Such vibrations are suppressed by the coupling 105, and the influence on the memory tag 106 can be reduced. In order to stably electrically contact the memory tag 106 with the body-side contacts provided in the apparatus main body 10B for reading information, vibrations may not be applied to the memory tag 106. Furthermore, by suppressing vibration of the electrical contacts 121 of the memory tag 106 with respect to the body-side contacts, wear of the memory tag 106 can be suppressed and the life of the memory tag 106 can be extended, and the electrical connection between the memory tag 106 and the body-side contacts can be stabilized.

### Configuration for Preventing Erroneous Mounting of Toner Cartridges

The first to fourth toner cartridges 1Y to 1K are each determined in advance to have a unique mounting position relative to the apparatus main body 10B, but have the same configuration except for the color of the toner stored therein. Each toner cartridge 1 has the same shape, including the shape (outer shape) when viewed in a direction parallel to the mounting direction relative to the apparatus main body 10B, and there is a possibility that the cartridges may be inserted in the wrong mounting position. The memory tag 106 also has the same shape across all toner cartridges 1 when viewed in a direction parallel to the mounting direction. Therefore, for example, if the second toner cartridge 1M is mounted in the mounting position where the first toner cartridge 1Y should be mounted and the memory tag 106 is electrically connected to the apparatus main body 10B, various problems may occur. For example, magenta toner and yellow toner, which are different colors, may be mixed together, or a desired color image may not be formed. The image forming apparatus 10 according to the present embodiment has a characteristic configuration for preventing the occurrence of a malfunction due to the erroneous mounting of the toner cartridge 1.

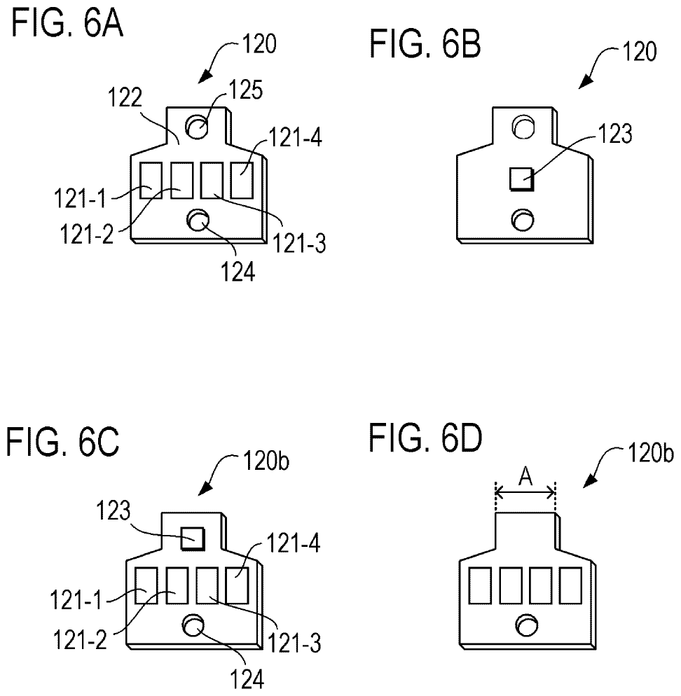

The memory tag 106 according to the present embodiment will be described with reference to FIGS. 6A to 6D, 7A to 7C, 8, and 9. The memory tag 106 is composed of a memory tag unit 131 composed of a memory tag substrate 120 as an electric substrate and a substrate holder 130 as a contact holder, a memory tag cover 132, and the like.

FIG. 6A is a perspective view of the memory tag substrate 120 as seen from the front side. FIG. 6B is a perspective view of the memory tag substrate 120 of FIG. 6A as seen from the rear side. FIG. 6C is a perspective view of a memory tag substrate 120b, which is another example of the configuration of the memory tag substrate 120, as seen from the front side. FIG. 6D is a perspective view of the memory tag substrate 120b of FIG. 6C as seen from the rear side.

Here, as an example of the configuration of the memory tag substrate 120, a memory tag substrate 120 in which electrical contacts and a processing circuit are mounted on a printed circuit board will be described. The memory tag substrate 120 has a plurality of electrical contacts 121 and a processing circuit 123 mounted on a printed circuit board 122. As described above, the processing circuit 123 can hold and provide information related to the toner cartridge 1. The processing circuit 123 can include hardware and software logic as necessary. For example, the processing circuit 123 can include a microprocessor or ASIC, and may include a non-volatile memory or a volatile memory. In addition, the memory tag substrate 120 does not need to be made of a printed circuit board, and can be made of any material or shape as long as the electrical contacts 121 can be arranged, electrical components such as the processing circuit 123 can be mounted, and the memory tag substrate 120 can operate without problems when supplying power or communicating. Generally, the memory tag substrates 120 of the same shape are used for the first to fourth toner cartridges 1.

As shown in FIG. 6A, the memory tag substrate 120 may be configured such that the processing circuit 123 and the electrical contacts 121 are arranged on different surfaces. Alternatively, as the memory tag substrate 120b shown in FIG. 6C, the processing circuit 123 and the electrical contacts 121 may be arranged on the same surface. In order to ensure that the memory tag substrate 120 is securely held when assembled to the substrate holder 130 described later, the memory tag substrate 120 shown in FIGS. 6A and 6B is provided with two substrate attachment holes 124 and 125. Here, the substrate attachment hole 124 is a round hole that serves as a reference for attachment, and the substrate attachment hole 125 is an elongated hole. On the other hand, the memory tag substrate 120b shown in FIGS. 6A and 6C has a portion having a width defined by dimension A at the top of the substrate.

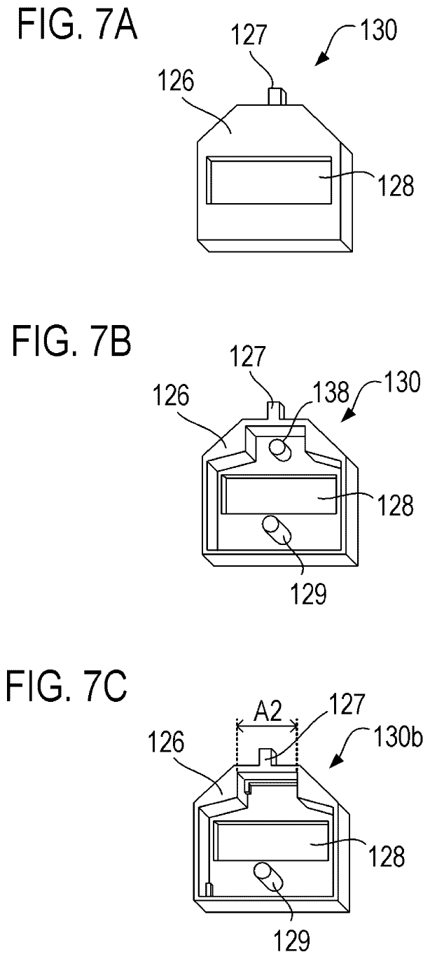

The substrate holder 130 in the present embodiment will be described with reference to FIGS. 7A to 7C. FIG. 7A is a perspective view of the substrate holder 130 for attaching the memory tag substrate 120 to the toner cartridge 1, as viewed from the front side. FIG. 7B is a perspective view of the substrate holder 130 corresponding to the memory tag substrate 120 configured as shown in FIGS. 6A and 6B, as viewed from the rear side. FIG. 7C is a perspective view of the substrate holder 130b corresponding to the memory tag substrate 120b configured as shown in FIGS. 6C and 6D, as viewed from the rear side. The configuration of the substrate holder 130b on the front side is the same as that of the substrate holder 130 shown in FIG. 7A.

As shown in FIG. 7A, the substrate holder 130 is composed of a holder housing 126, a projection 127, and an opening 128. The memory tag substrate 120 is attached from the rear side of the substrate holder 130, and is fixed so that the electrical contacts 121 on the memory tag substrate 120 are visible through the opening 128 of the substrate holder 130.

On the rear side of the substrate holder 130 shown in FIG. 7B, cylindrical projections 129 and 138 are provided on the bottom surface of a recess corresponding to the external shape of the memory tag substrate 120 shown in FIGS. 6A and 6B, and an opening 128 is opened. These projections 129 and 138 are inserted into the substrate attachment holes 124 and 125 of the memory tag substrate 120 shown in FIGS. 6A and 6B that are fitted into the recess, respectively, and the memory tag substrate 120 can be assembled to the substrate holder 130. The projection 129 is higher than the projection 138 so as to enter a memory tag attachment hole provided in the memory tag space of the toner cartridge, which will be described later. The projection 127 is provided so as to protrude in a direction intersecting (orthogonal in the present embodiment) the mounting direction.

Also, on the rear side of the substrate holder 130b shown in FIG. 7C, a cylindrical projection 129 is provided on the bottom surface of a recess corresponding to the outer shape of the memory tag substrate 120b shown in FIGS. 6C and 6D, and an opening 128 is opened. The projection 129 is inserted into the substrate attachment hole 124 of the memory tag substrate 120b shown in FIGS. 6C and 6D that is fitted into the recess, and the memory tag substrate 120b can be assembled to the substrate holder 130b. The memory tag substrate 120b is pushed in from the rear side of the substrate holder 130 and fixed with a member having a fixing function (not shown). At that time, the recess of the substrate holder 130b is designed to have a portion having a width defined by the dimension A2 with respect to the dimension A of the upper part of the memory tag substrate 120b shown in FIG. 6B, and A≤A2.

The substrate holders 130 and 130b may be made of an insulating material such as a resin to prevent short circuits in the electric circuit including the electrical contacts 121 and the processing circuit 123 on the memory tag substrates 120 and 120b. In the present embodiment, the substrate holders 130 and 130b can be used as components having the same shape and molded using the same mold for the first to fourth toner cartridges.

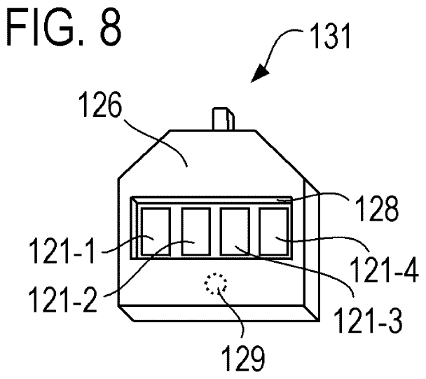

FIG. 8 is a perspective view of the memory tag unit 131 in which the memory tag substrate 120 is assembled to the substrate holder 130, as seen from the front side. The electrical contacts 121 can be seen through the opening 128. The circle indicated by the dashed line indicates the position where the projection 129 is disposed. The memory tag unit in which the memory tag substrate 120b is assembled to the substrate holder 130b is similarly configured.

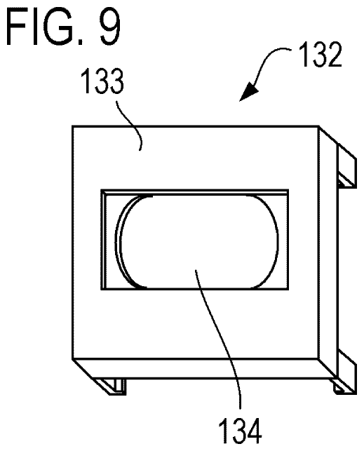

FIG. 9 is a perspective view, seen from the front side, of the memory tag cover 132 that secures and protects the memory tag unit 131 when the memory tag unit 131 is attached to the toner cartridge 1. The memory tag cover 132 has a cover housing 133. The cover housing 133 is provided with an opening 134. The memory tag cover 132 is attached so as to cover the memory tag unit 131 so that a part of the memory tag unit 131, particularly the area including the electrical contacts 121 can be seen from the outside through the opening 134 when the memory tag unit 131 is attached to the toner cartridge 1. The memory tag cover 132 may be made of an insulating material such as a resin, or a metallic material.

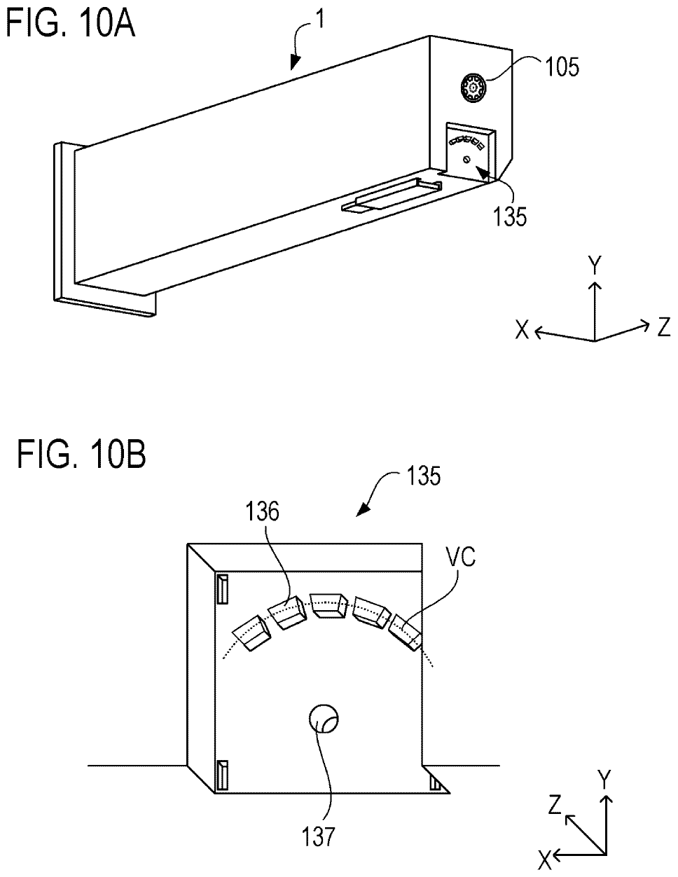

FIG. 10A is a perspective view of the toner cartridge 1 from the lower rear side to clearly show the memory tag space 135 for arranging the memory tag 106 in the toner cartridge 1. FIG. 10B is an enlarged perspective view of the memory tag space 135 and its vicinity. The memory tag space 135 as an attachment portion is composed of a plurality of projections 136 arranged at intervals and a memory tag attachment hole 137. The projection 129 of the substrate holder 130 shown in FIG. 7B or the projection 129 of the substrate holder 130b shown in FIG. 7C is inserted into this memory tag attachment hole 137.

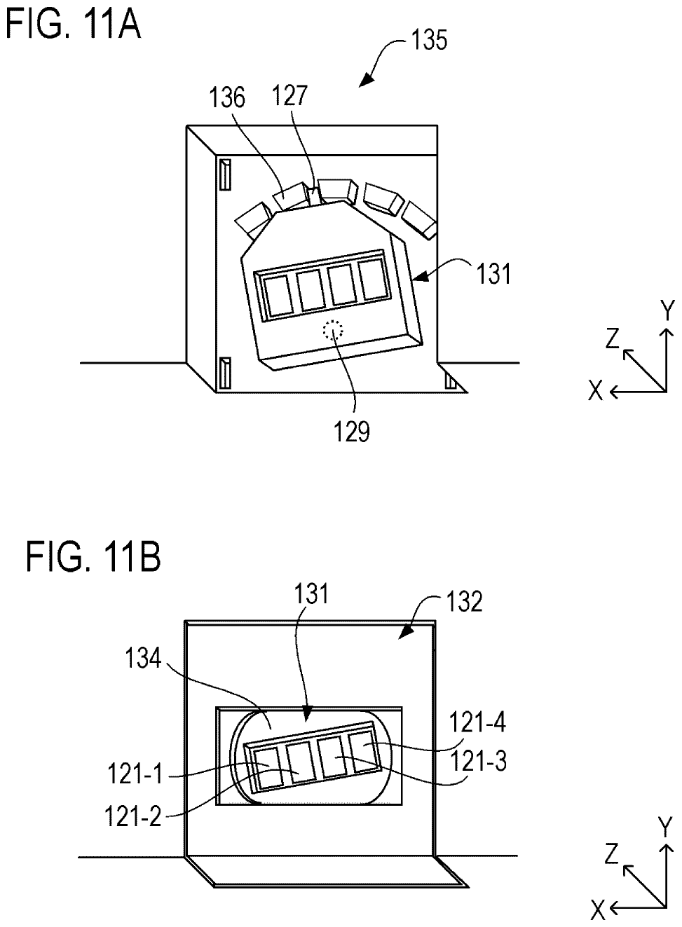

FIG. 11A is a perspective view showing the state in which the memory tag unit 131 is assembled in the memory tag space 135. The memory tag space 135 as an attachment portion to which the memory tag unit 131 is attached has the same shape across all toner cartridges 1. The projection 129 (positioned portion) of the memory tag unit 131 and the memory tag attachment hole 137 (positioning portion) of the memory tag space 135 engage with each other so as to be rotatable around a rotation axis along the mounting direction of the toner cartridge 1. The projection 127 (rotation-restricted portion) of the memory tag unit 131 is selectively inserted between two adjacent projections 136 among a plurality of projections 136 (rotation-restricting portions) arranged in the memory tag space 135. The attachment angle of the memory tag unit 131 relative to the memory tag space 135 is determined depending on which two projections 136 the projection 127 is engaged between. That is, the projection 136 is a rotation stopper that engages with the projection 127 so as to restrict the rotation of the memory tag unit 131 relative to the memory tag space 135 around the rotation axis that passes through the projection 129 or the memory tag attachment hole 137 and is along the mounting direction. The projections 136 are arranged in a line on a virtual arc (virtual arc VC in FIG. 10B) centered around the rotation axis. This configuration allows the memory tag unit 131 to be selectively attached to the memory tag space 135 at different attachment angles around the rotation axis of the projection 129 relative to the memory tag attachment hole 137, that is, around the rotation axis perpendicular to the XY plane. As a result, the memory tag units 131 have the same shape when viewed in a direction parallel to the mounting direction in each toner cartridge 1, but the angle at which they are attached to the toner cartridge 1 can be configured to differ depending on the color of the toner cartridge 1.

FIG. 11B is a perspective view showing a state in which the memory tag cover 132 is attached from the state shown in FIG. 11A. Even if the memory tag unit 131 is attached at multiple different angles, a part of the memory tag unit 131 and the electrical contact 121 can be seen through the opening 134 of the memory tag cover 132. In the present embodiment, the memory tag cover 132 can be used as components having the same shape and molded using the same mold for the first to fourth toner cartridges. Instead of arranging the projection 136 in the memory tag space 135, a projection may be provided on the memory tag cover 132 to attach the memory tag unit 131 at a different angle.

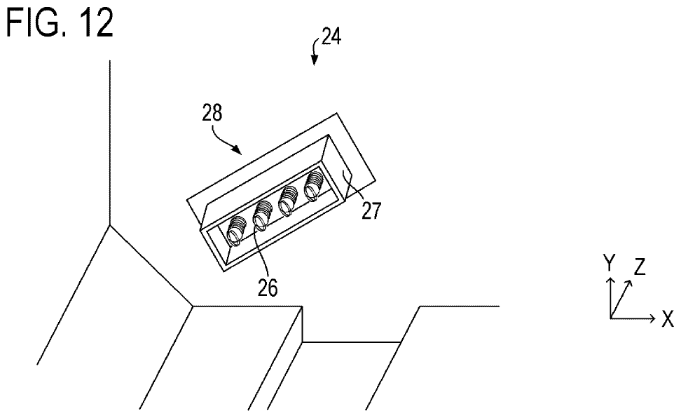

FIG. 12 is an enlarged perspective view of the body-side contact 28 arranged in the toner cartridge mounting portion 24. The body-side contact 28 is composed of contact springs 26 as multiple contact terminals for electrically contacting the electrical contacts 121 of the memory tag 106, and a guide member 27 as a terminal holder surrounding the contact springs. The body-side contact 28 and the electrical contact 121 as the cartridge-side contact are configured to contact each other via a floating structure configured so that at least one of them has a degree of freedom in position (a degree of freedom in the relative position that can form a connection state). That is, when the toner cartridge 1 is mounted in the apparatus main body 10B, even if there is some misalignment between the electrical contact 121 and the body-side contact 28, electrical contact can be reliably achieved.

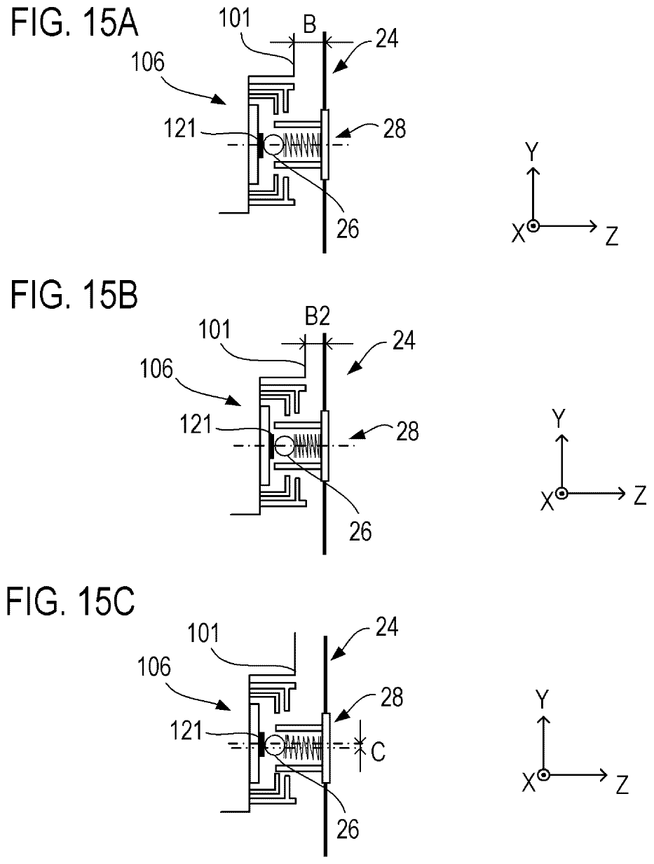

A specific floating structure will be described with reference to FIGS. 15A to 15C. FIGS. 15A to 15C are enlarged views showing the vicinity of the electrical contact 121 and the body-side contact 28 of the memory tag 106. Here, a floating structure is employed, in which the contact between both contacts can follow within a predetermined range by the expansion and contraction and/or bending of the contact spring 26 of the body-side contact 28. That is, in the memory tag 106 of the present embodiment, the normal direction of the surface of the electrical contact 121 (cartridge contact surface) is the mounting direction of the toner cartridge 1 to the apparatus main body 10B. In addition, the direction in which each surface (each cartridge contact surface) of the multiple electrical contacts 121 is aligned is a direction intersecting (orthogonal in the present embodiment, though not limited thereto) the mounting direction. The alignment direction of the cartridge contact surface differs depending on the color of the toner cartridge 1.

FIG. 15A shows a state where the electrical contact 121 and the body-side contact 28 are in contact at positions defined by the design tolerance specifications. At this time, the distance in the Z direction between the replenishment container 101 and the toner cartridge mounting portion 24 of the toner cartridge 1 at a representative position is defined as B.

FIG. 15B shows a state where the replenishment container 101 and the toner cartridge mounting portion 24 approach each other and the distance in the Z direction becomes B2 (<B). The contact spring 26 contracts, thereby maintaining contact between the electrical contact 121 and the body-side contact 28.

FIG. 15C shows a state where the replenishment container 101 is shifted by a distance C in the Y direction relative to the toner cartridge mounting portion 24. The contact between the electrical contact 121 and the body-side contact 28 is maintained by the bending of the contact spring 26.

Here, typical positional deviations in the Z direction and the Y direction have been exemplified, but it is desirable to provide a floating structure that can follow positional deviations in other directions. Here, a floating structure having positional freedom due to the expansion and contraction and/or bending of the contact spring 26 has been described, but a floating structure may be employed in which the guide member 27 has positional freedom relative to the toner cartridge mounting portion 24. Alternatively, a floating structure may be adopted in which the memory tag unit 131 has positional freedom relative to the toner cartridge 1.

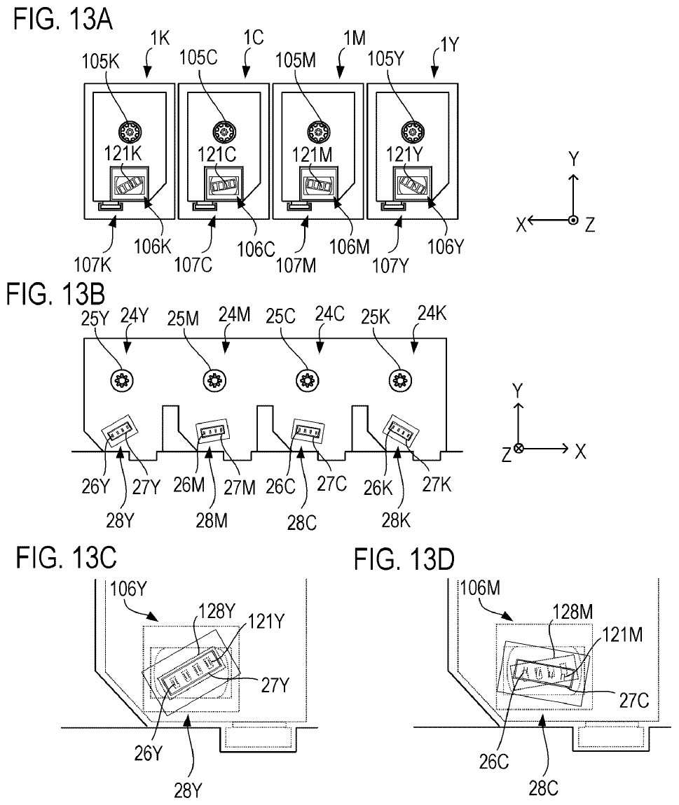

With reference to FIGS. 13A to 13D, a specific mechanism for preventing erroneous mounting of the toner cartridge 1 will be described.

FIG. 13A is a view of the rear side of the toner cartridge 1, that is, the side where the coupling 105 of the toner cartridge 1 is arranged, with the first to fourth toner cartridges 1Y to 1K mounted in the apparatus main body 10B. The memory tag 106 is disposed between the coupling 105 and the toner discharge portion 107 disposed on the bottom surface of the toner cartridge 1. More specifically, when viewed in a direction parallel to the mounting direction (Z direction) of the toner cartridge 1 to the apparatus main body 10B, at least a part of the electrical contact 121 of the memory tag 106 is disposed above the toner discharge portion 107 and below the rotation axis G of the coupling 105. In addition, in the mounting direction of the toner cartridge 1 to the apparatus main body 10B, the electrical contact 121 of the memory tag 106 is disposed downstream of the toner discharge portion 107.

In addition, the electrical contacts 121Y to 121K included in the memory tags 106Y to 106K disposed in the first to fourth toner cartridges 1Y to 1K have different angles when viewed in a direction parallel to the mounting direction (Z direction) of the toner cartridge 1 to the apparatus main body 10B. That is, the electrical contacts 121Y to 121K are arranged in such a way that their orientations (angles, postures) around a rotation axis extending in a direction (Z direction) perpendicular to the toner discharge direction (−Y direction) in the toner discharge portion 107 are different from each other in the XY plane. The rotation axis at this time is the rotation axis of the projection 129 relative to the memory tag attachment hole 137 shown in FIGS. 10A, 10B, 11A, and 11B.

FIG. 13B is a front view of the first to fourth toner cartridge mounting portions 24Y to 24K, which are positions for mounting the first to fourth toner cartridges 1Y to 1K in the apparatus main body 10B. The first to fourth toner cartridge mounting portions 24Y to 24K are provided with the body-side coupling 25 and the body-side contacts 28. Furthermore, the body-side contacts 28 as terminals provided in the toner cartridge mounting portion 24 are composed of contact springs 26 as a plurality of contact terminals for electrically contacting the electrical contacts 121 of the memory tag 106, and a guide member 27 surrounding the contact springs.

The body-side contacts 28Y to 28K, like the electrical contacts 121Y to 121K, have different angles when viewed in a direction parallel to the insertion/removal direction (Z direction) of the toner cartridge 1 relative to the apparatus main body 10B. That is, the body-side contacts 28Y to 28K are arranged in different postures (different angles) in the XY plane, rotated around a rotation axis extending in a direction (Z direction) perpendicular to the toner discharge direction (−Y direction) in the toner discharge portion 107. The manner in which this posture is changed corresponds to the manner in which the posture of the electrical contacts 121Y to 121K are changed. That is, the body-side contacts 28Y to 28K are disposed at different angles on the XY plane so that they can come into contact with the electrical contacts 121Y to 121K included in the memory tags 106Y to 106K of the toner cartridges 1 of the corresponding colors.

More specifically, the posture (angle) or contact structure of the body-side contact 28Y is determined so that it can come into contact with the electrical contact 121Y among the electrical contacts 121Y to 121K, but cannot come into contact with the electrical contacts 121M, 121C, and 121K. Similarly, the posture (angle) or contact structure of the body-side contact 28M is determined so that it can come into contact with the electrical contact 121M among the electrical contacts 121Y to 121K, but cannot come into contact with the electrical contacts 121Y, 121C, and 121K. Similarly, the posture (angle) or contact structure of the body-side contact 28C is determined so that it can come into contact with the electrical contact 121C among the electrical contacts 121Y to 121K, but cannot come into contact with the electrical contacts 121Y, 121M, and 121K. Similarly, the posture (angle) or structure of the body-side contact 28K is determined so that it can contact the electrical contact 121K among the electrical contacts 121Y to 121K, but cannot contact the electrical contacts 121Y, 121M, and 121C.

Here, a configuration using a terminal with a ring-shaped tip is described as the contact terminal, but the shape of the contact terminal is not limited, such as a ball-shaped terminal or a pin-shaped terminal. The tip shape of the contact terminal is not limited to a specific configuration, but the terminal may have a spring property to prevent damage when the contacts come into contact with each other.

FIG. 13C is a diagram showing a case where a compatible toner cartridge 1 among four types of toner cartridges 1 is mounted in one of the four toner cartridge mounting portions 24. FIG. 13D is a diagram showing a case where an incompatible (mismatched) toner cartridge 1 among four types of toner cartridges 1 is inserted (mounted) in one of the four toner cartridge mounting portions 24.

FIG. 13C shows an enlarged view, from the front side, of the state where the first toner cartridge 1Y, which is a compatible cartridge, is correctly mounted in the first toner cartridge mounting portion 24Y When the first toner cartridge 1Y is mounted in the first toner cartridge mounting portion 24Y, the guide member 27Y surrounding the body-side contact 26Y can enter the opening 128Y provided in the memory tag 106Y. This ensures that the contact between the body-side contact 26Y and the electrical contact 121Y of the memory tag 106Y is established.

In contrast, FIG. 13D shows an enlarged view, from the front side, of the state where the second toner cartridge 1M, which is an incompatible cartridge, is mistakenly inserted in the third toner cartridge mounting portion 24C. When the second toner cartridge 1M is inserted into the third toner cartridge mounting portion 24C, the guide member 27C surrounding the body-side contact 26C interferes with the opening 128M (the edge around the opening 128M) provided in the memory tag 106M. As a result, the contact between the body-side contact 26C and the electrical contact 121M of the memory tag 106M is not established.

When the second toner cartridge 1M is inserted (mounted) into the third toner cartridge mounting portion 24C, the connection between the body-side contact 26C and the electrical contact 121M is not established, so the control portion of the apparatus main body 10B cannot control the second toner cartridge 1M. As a result, the control portion can detect that an incompatible cartridge has been inserted (mounted) into the third toner cartridge mounting portion 24C, thereby preventing the image forming operation from being performed while the incompatible cartridge remains mounted. In other words, it is possible to prevent the erroneous mounting into the third toner cartridge mounting portion 24C (to encourage the user to resolve the erroneous mounting state).

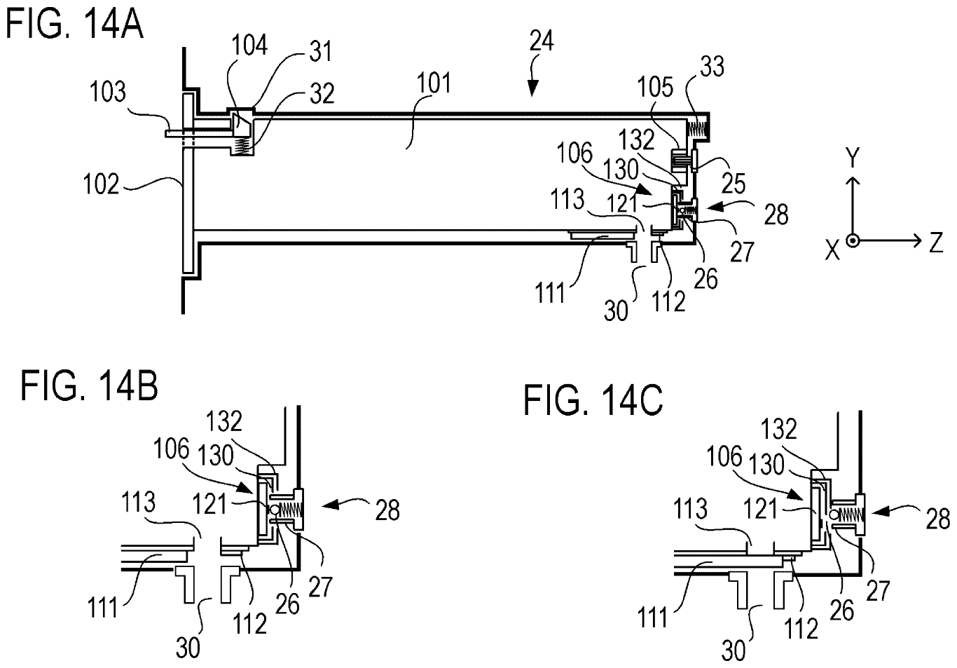

A specific mechanism for preventing erroneous mounting of the toner cartridge 1 will be described with reference to FIGS. 14A to 14C. FIGS. 14A to 14C are longitudinal cross-sectional views of the toner cartridge mounting portion 24 and the toner cartridge 1.

FIG. 14A shows a state in which the correct toner cartridge 1 corresponding to the toner cartridge mounting portion 24 is mounted. FIG. 14B is an enlarged view showing the state near the memory tag 106 at that time. The coupling 105 is configured to engage with the body-side coupling 25, thereby allowing power from the apparatus main body 10B side to be transmitted to the toner cartridge 1. The guide member 27 of the body-side contact 28 also enters the opening 134 of the memory tag cover 132 in the memory tag 106 and the opening 128 of the substrate holder 130, and the electrical contact 121 of the memory tag 106 and the contact spring 26 of the body-side contact 28 are in contact. That is, the memory tag 106 and the image forming apparatus 10 are in a state in which they can communicate with each other.

Since the control portion of the apparatus main body 10B is in a state capable of controlling the toner cartridge 1, it can move the shutter member 111 arranged at the bottom of the toner cartridge 1 to the open position. As a result, toner can be supplied from the discharge port 113 toward the toner receiving port 30 arranged at the bottom of the toner cartridge mounting portion 24. At this time, the locking member 104 connected to the handle 103 arranged at the front surface of the toner cartridge 1 is inserted into a concave lock hole 31 arranged in the toner cartridge mounting portion 24 by the biasing force of the spring member 32. The locking member 104 as a restricting member is configured to restrict the movement of the toner cartridge 1 in the direction of removal from the toner cartridge mounting portion 24. The locking member 104 is configured to be able to take a restricting position where the movement of the toner cartridge 1 is restricted and a non-restricting position where the movement is not restricted. The locking member 104 can move to the restricting position when the toner cartridge 1 is in a predetermined mounting position (mounting completion position) in the toner cartridge mounting portion 24. When the toner cartridge 1 is in the predetermined mounting position, the spring member 33 (biasing member) provided in the toner cartridge mounting portion 24 biases the toner cartridge 1 in a direction from the specified mounting position toward the upstream side in the mounting direction (direction of removal from the toner cartridge mounting portion 24). The locking member 104 in the restricting position restricts the movement of the toner cartridge 1 against the biasing force of the spring member 33. As a result, the toner cartridge 1 is locked in the mounted state in the apparatus main body 10B.

When the user presses down the handle 103 in the −Y direction, the locking member 104 also moves down in the −Y direction against the biasing force of the spring member 32, and the upper part of the locking member 104 comes out of the lock hole 31. Then, the toner cartridge 1 is pushed out in the −Z direction by the biasing force of the spring member 33 provided in the toner cartridge mounting portion 24 as a biasing member. The toner cartridge 1 is maintained in a state where it is not mounted in the apparatus main body 10B, and is in an unlocked state.

FIG. 14C is an enlarged view showing the state near the memory tag 106 when an incompatible, incorrect toner cartridge 1 is inserted (mounted) into the toner cartridge mounting portion 24 as an incompatible cartridge. As shown in FIG. 14C, the guide member 27 of the body-side contact 28 cannot enter and interfere with the opening 134 of the memory tag cover 132 in the memory tag 106 or the opening 128 of the substrate holder 130. The substrate holder 130 as a contact holder is provided so as to surround the electrical contact 121 and to be downstream in the mounting direction of the toner cartridge 1 to the apparatus main body 10B. As a result, the electrical contact 121 of the memory tag 106 cannot come into contact with the contact spring 26 of the body-side contact 28, and the memory tag 106 and the image forming apparatus 10 cannot communicate with each other. Since the control portion of the apparatus main body 10B cannot control the toner cartridge 1, the shutter member 111 arranged at the bottom of the toner cartridge 1 cannot move from the closed position to the open position, and the toner cannot be supplied from the discharge port 113 to the toner receiving port 30. The same state occurs even in an apparatus configuration in which the shutter member 111 is not controlled by the control portion and a mechanism is provided for driving the shutter member 111 in conjunction with the operation of inserting the toner cartridge 1 to the back of the mounting portion. In other words, due to interference between the guide member 27 of the body-side contact 28 and the memory tag cover 132 or the substrate holder 130, the incompatible toner cartridge 1 cannot reach the predetermined mounting completion position and cannot be completely mounted to the apparatus main body 10B.

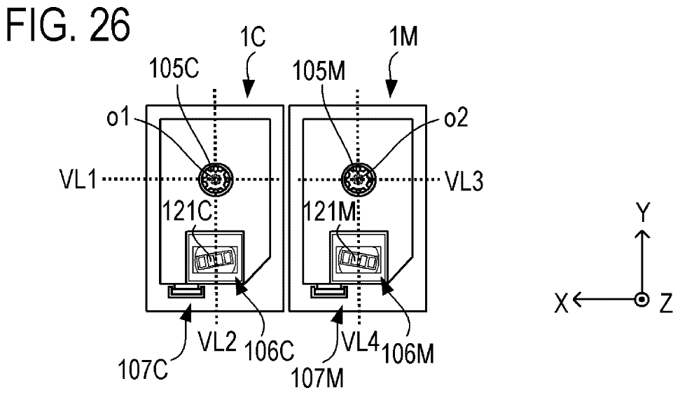

FIG. 26 is a schematic diagram for explaining the difference in the arrangement of the memory tag 106 for each toner cartridge 1, and here, the configuration of the toner cartridges 1C and 1M when viewed in a direction parallel to the mounting direction to the apparatus main body 10B is shown as a representative example. Consider a two-dimensional coordinate system (first coordinate system) that is configured with the rotation axis of the coupling 105C as the origin o1, a virtual line VL1 (first virtual line) that passes through the rotation axis and extends in the horizontal direction, and a virtual line VL2 (second virtual line) that passes through the rotation axis and extends in the gravitational direction, when viewed in a direction parallel to the mounting direction. Similarly, consider a two-dimensional coordinate system (second coordinate system) that is configured with the rotation axis of the coupling 105M as the origin o2, a virtual line VL3 (third virtual line) that passes through the rotation axis and extends in the horizontal direction, and a virtual line VL4 (fourth virtual line) that passes through the rotation axis and extends in the gravitational direction, when viewed in a direction parallel to the mounting direction. The coordinates of the electrical contact 121C in the former first coordinate system and the coordinates of the electrical contact 121M in the latter second coordinate system will differ from each other when the first coordinate system and the second coordinate system are overlaid so that their respective origins coincide. In other words, the coordinates of the memory tag substrate 120 provided in each of the memory tag 106C and the memory tag 106M will have different regions from each other when the first coordinate system and the second coordinate system are overlaid so that their respective origins coincide. This is the same for the four types of toner cartridges 1Y to 1K, including toner cartridges 1Y and 1K.

### Effects of Present Embodiment

As described above, the following effects can be obtained by using the image forming apparatus 10 and toner cartridge 1 according to the present embodiment.

By assembling the memory tag 106 so that the electrical contacts 121 are arranged on the XY plane perpendicular to the longitudinal direction (Z axis) of the toner cartridge 1, the amount of toner that the toner cartridge 1 can store can be increased. By configuring the angle of the electrical contacts 121 and the corresponding angle of the contact spring 26 of the body-side contact 28 in the XY plane so as to differ for each color, it is possible to reliably prevent the erroneous mounting of toner cartridges 1 of different colors.

Furthermore, in the first to fourth toner cartridges 1Y to 1K, the substrate holders 130 of the memory tags 106, which have the same configuration and shape, are attached to the toner cartridge 1 at different angles for each color. That is, in the first to fourth toner cartridges 1Y to 1K, the substrate holder 130 and the memory tag cover 132 can be commonly used as components having the same shape, molded using the same mold. This is also effective in reducing the cost of manufacturing parts.

Furthermore, by surrounding the memory tag 106 with the memory tag cover 132, it is possible to achieve both the protection of the electrical contact 121 and the function of preventing the toner cartridge 1 from being erroneously attached.

Note that, in the relationship between the present embodiment and the present disclosure, for example, if the toner cartridge 1Y of the toner cartridges 1Y to 1K is the first toner cartridge, any one (or more) of the toner cartridges 1M, 1C, and 1K, excluding the toner cartridge 1Y, is the second toner cartridge. Similarly, if the toner cartridge 1M is the first toner cartridge, any one (or more) of the toner cartridges 1Y, 1C, and 1K, excluding the toner cartridge 1M, is the second toner cartridge. Similarly, if the toner cartridge 1C is the first toner cartridge, any one (either one or more) of the toner cartridges 1M, 1Y, and 1K, excluding the toner cartridge 1C, is the second toner cartridge. Similarly, if the toner cartridge 1K is the first toner cartridge, any one (either one or more) of the toner cartridges 1M, 1Y, and 1C, excluding the toner cartridge 1K, is the second toner cartridge.

Similarly, if one of the photosensitive drums 7Y to 7K is the first photosensitive drum, the other photosensitive drum (either one or more) is the second photosensitive drum. Similarly, if the longitudinal direction of one of the photosensitive drums 7Y to 7K is the first direction, the longitudinal direction of the other photosensitive drum (either one or more) is the second direction. Similarly, if one of the developing rollers 11Y to 11K is the first developing roller, the other developing roller (either one or more) is the second developing roller. Similarly, when one of the developing units 6Y to 6K is the first developing unit, the other developing unit (either one or more) is the second developing unit. Similarly, when the toner storage portion of one of the developing units 6Y to 6K is the first toner storage portion, the toner storage portion (either one or more) of the other developing units is the second toner storage portion. Similarly, when one of the four color toners is the first toner, the other toner (either one or more) is the second toner.

Similarly, when the replenishment container 101 of one of the toner cartridges 1Y to 1K is the first container, the replenishment container 101 of the other toner cartridge (either one or more) is the second container. Similarly, when the discharge port 113 of one of the toner cartridges 1Y to 1K is the first discharge port, the discharge port 113 of the other toner cartridge (either one or more) is the second discharge port. Similarly, when the screw unit 160 of one of the toner cartridges 1Y to 1K is the first conveying member, the screw unit 160 (either one or more) of the other toner cartridges is the second conveying member. Similarly, when the agitation unit 170 of one of the toner cartridges 1Y to 1K is the first agitation member, the agitation unit 170 (either one or more) of the other toner cartridges is the second agitation member. Similarly, when one of the couplings 105Y to 105K is the first driving force receiving member, the other coupling (either one or more) is the second driving force receiving member. Similarly, when the rotation axis G of one of the couplings 105Y to 105K is the first rotation axis, the rotation axis G of the other coupling (either one or more) is the second rotation axis. Similarly, if the rear surface (end surface in the mounting direction) of one of the toner cartridges 1Y to 1K is the first end surface, the rear surface (end surface in the mounting direction) of the other toner cartridge (either one or more) is the second end surface.

Similarly, when one of the memory tags 106Y to 106K is the first memory unit, the other memory tag (either one or more) is the second memory unit.

Similarly, when the memory tag substrate 120 of one of the memory tags 106Y to 106K is the first electric substrate, the memory tag substrate 120 (either one or more) of the other memory tag is the second electric substrate. Similarly, when the substrate holder 130 of one of the memory tags 106Y to 106K is the first contact holder, the substrate holder 130 (either one or more) of the other memory tag is the second contact holder. Similarly, when one of the surfaces of the electrical contacts 121Y to 121K is the first cartridge contact surface, the other surface (either one or more) is the second cartridge contact surface.

Similarly, when the memory tag space 135 of one of the toner cartridges 1Y to 1K is the first attachment portion, the memory tag space 135 (either one or more) of the other toner cartridge is the second attachment portion. Similarly, when the projection 129 of the memory tag unit 131 of one of the memory tags 106Y to 106K is the first positioned portion, the projection 129 (either one or more) of the memory tag unit 131 of the other memory tag is the second positioned portion. Similarly, when the memory tag attachment hole 137 of the memory tag space 135 of one of the toner cartridges 1Y to 1K is the first positioned portion, the memory tag attachment hole 137 (either one or more) of the memory tag space 135 of the other toner cartridge is the second positioned portion. Similarly, if the projection 127 of the memory tag unit 131 of one of the memory tags 106Y to 106K is the first rotation-restricted portion, the projection 127 (either one or more) of the memory tag unit 131 of the other memory tags is the second rotation-restricted portion. Similarly, if the projection 136 of the memory tag space 135 of one of the toner cartridges 1Y to 1K is the first rotation-restricted portion, the projection 136 (either one or more) of the memory tag space 135 of the other toner cartridge is the second rotation-restricted portion. Similarly, if the rotation axis that is the rotation center of the memory tag unit 131 relative to the memory tag space 135 of one of the toner cartridges 1Y to 1K is the first rotation axis, the rotation axis (either one or more) that is the rotation center of the memory tag unit 131 relative to the memory tag space 135 of the other toner cartridge is the second rotation axis.

Similarly, when one of the toner cartridge mounting portions 24Y to 24K is the first mounting portion, the other toner cartridge mounting portion (either one or more) is the second mounting portion. Similarly, when one of the body-side contacts 28Y to 28K is the first terminal, the other body-side contact (either one or more) is the second terminal. Similarly, when one of the body-side couplings 25Y to 25K is the first driving member, the other body-side coupling (either one or more) is the second driving member. Similarly, when one of the guide members 27Y to 27K is the first terminal holder, the other guide member (either one or more) is the second terminal holder.

Similarly, when the spring member 33 of one of the toner cartridge mounting portions 24Y to 24K is defined as the first biasing member, the spring member 33 (either one or more) of the other toner cartridge mounting portion is defined as the second biasing member. Similarly, when the predetermined mounting position (mounting completion position) of the toner cartridge in one of the toner cartridge mounting portions 24Y to 24K is defined as the first mounting position, the predetermined mounting position (mounting completion position) (either one or more) of the toner cartridge in the other toner cartridge mounting portion is defined as the second mounting position. Similarly, when the restricting position of the locking member 104 of one of the toner cartridge mounting portions 24Y to 24K is defined as the first restricting position, the restricting position (either one or more) of the locking member 104 of the other toner cartridge mounting portion is defined as the second restricting position. Similarly, if the non-restriction position of the locking member 104 of one of the toner cartridge mounting portions 24Y to 24K is the first non-restriction position, the non-restriction position (either one or more) of the locking member 104 of the other toner cartridge mounting portion is the second non-restriction position.

The relationship of the configuration of the present embodiment other than the above to the present disclosure may be considered in the same manner as above.

### Second Embodiment

The second embodiment of the present disclosure will be described. Since the second embodiment is configured by partially changing the configuration described in the first embodiment, the same configuration as the first embodiment will be omitted from the illustration or will be described by assigning the same reference numerals in the figures. Items of the second embodiment that are not described here are the same as those of the first embodiment.

### Configuration of Image Forming Apparatus

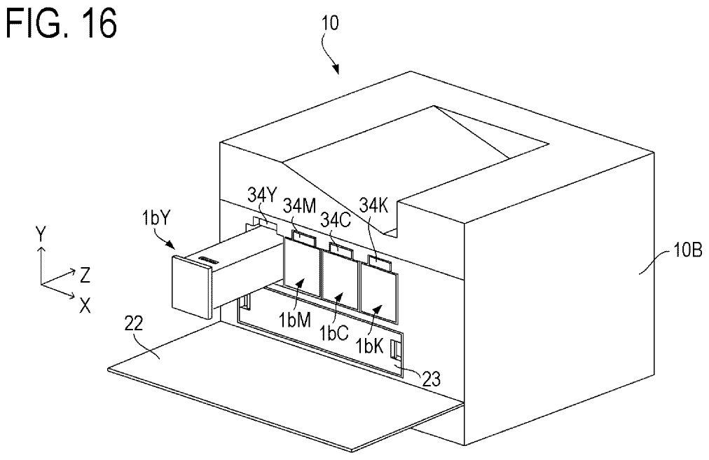

As shown in FIG. 16, when the front cover 22 covering the front surface of the image forming apparatus 10 is opened, a toner cartridge 1b can be attached and detached via a mounting unit such as a mounting guide (not shown) and a positioning member (not shown) provided on the main body of the image forming apparatus 10. In the present embodiment, by pressing a toner cartridge removal button 34 provided on the apparatus main body 10B above the toner cartridge 1b, the corresponding toner cartridge 1b moves to a position where it can be removed. In FIG. 16, the first toner cartridge 1bY is shown in a state where it can be removed by pressing the first toner cartridge removal button 34Y, and the second to fourth toner cartridges 1bM to 1bK are shown mounted in the apparatus main body 10B.

### Overall Configuration of Toner Cartridge

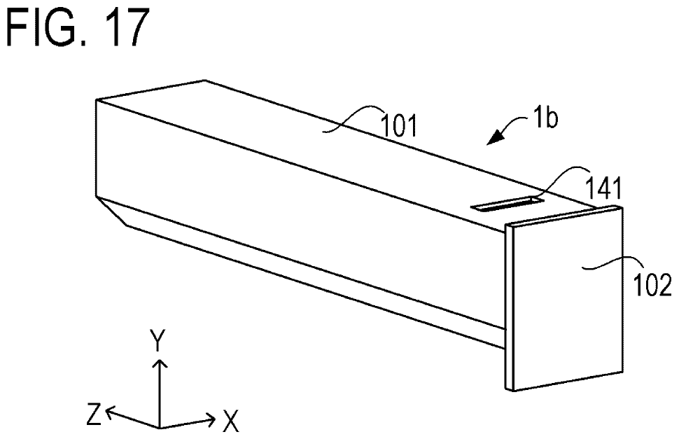

FIG. 17 is a perspective view of the toner cartridge 1b of the present embodiment, seen from the upper front side. The toner cartridge 1b has a replenishment container 101 as a casing and a front cover 102 provided on the surface that is placed at the front when it is mounted in the apparatus main body 10B. In the present embodiment, the locking mechanism of the toner cartridge 1b is provided in the apparatus main body 10B so that the number of members on the toner cartridge 1b side can be reduced. The recess 141 on the upper part of the toner cartridge 1b is a hole into which the protruding member of the locking mechanism described later is inserted.

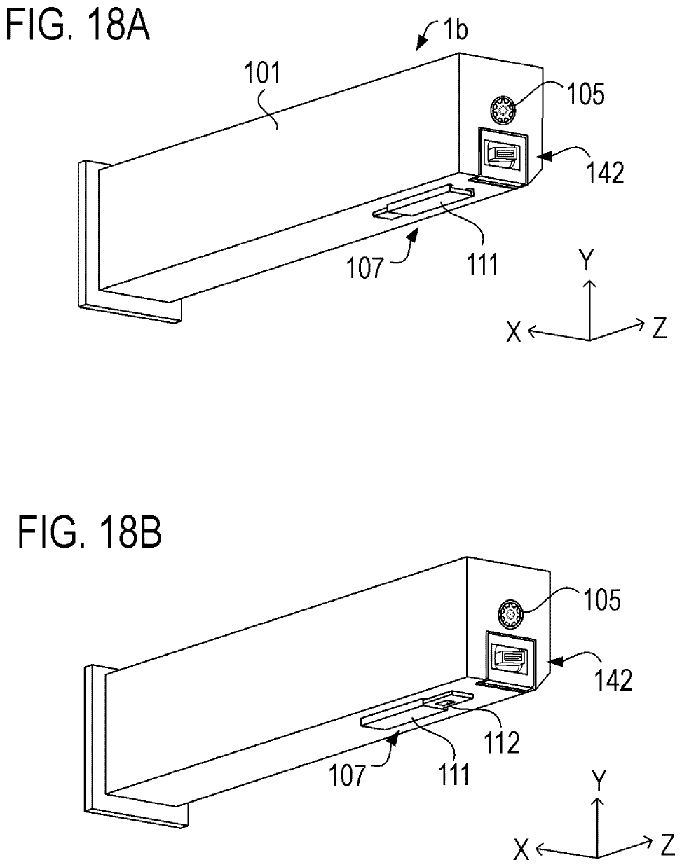

FIGS. 18A and 18B are perspective views of the toner cartridge 1b, seen from the lower rear side. FIG. 18A shows the toner cartridge 1b in a state in which it is mounted to the image forming apparatus 100 and the toner can be discharged, and FIG. 18B shows the toner cartridge 1b in a state in which it is not mounted to the image forming apparatus 10 and the toner cannot be discharged. The above-mentioned coupling 105 (driving force receiving part) is provided on the rear side of the toner cartridge 1b. The toner discharge portion 107 is provided on the bottom surface of the toner cartridge 1b.

In the Z direction of the toner cartridge 1b, a memory tag 142 is provided on the rear surface of the toner cartridge 1b between the coupling 105 and the toner discharge portion 107. When the toner cartridge 1b is mounted in the apparatus main body 10B, the electrical contacts 121 (cartridge-side contacts) of the memory tag 142 come into electrical contact with the body-side contacts of the apparatus main body 10B.

### Configuration for Preventing Erroneous Mounting of Toner Cartridges

In the present embodiment, a configuration for preventing erroneous mounting of the first to fourth toner cartridges 1bY to 1bK in incompatible mounting positions with respect to the apparatus main body 10B (prompting the user to resolve the erroneous mounting state) will be described.

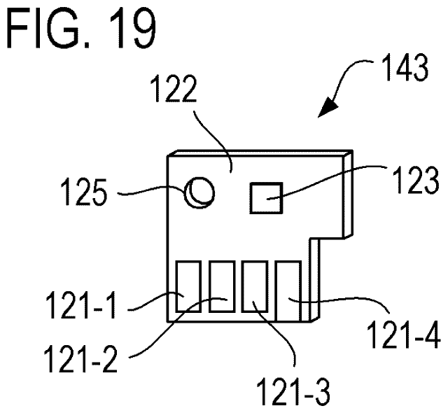

FIG. 19 shows a memory tag substrate 143 according to the present embodiment. Similar to the first embodiment, a plurality of electrical contacts 121 and a processing circuit 123 are mounted on a printed circuit board 122. In addition, the printed circuit board 122 has an L-shape and is provided with a substrate attachment hole 125 so that the substrate can be inserted into the memory tag holder described later without making a mistake in the orientation. The sizes of the plurality of electrical contacts 121 may all be the same, or some of them may differ. The processing circuit 123 and the electrical contacts 121 may be arranged on the same surface of the printed circuit board 122 or on different surfaces. The configuration of the memory tag substrate 143 described here is an example, and a different configuration or material may be used as long as it has the same function.

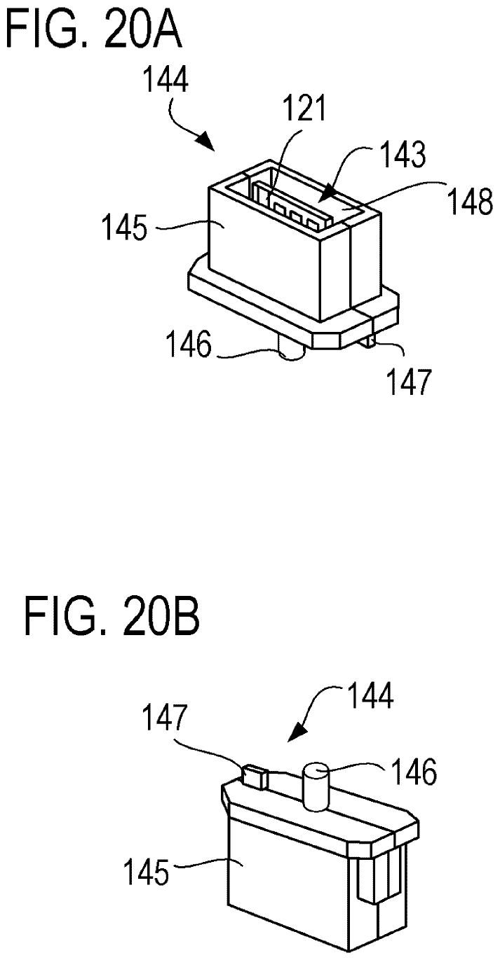

FIG. 20A is a perspective view of a memory tag unit 144 in which the memory tag substrate 143 is inserted into a substrate holder 145 to attach the memory tag substrate 143 to the toner cartridge 1b, as seen from a viewpoint where the memory tag substrate 143 is exposed. FIG. 20B is a perspective view of the memory tag unit 144 as seen from the opposite viewpoint to that of FIG. 20A. The memory tag unit 144 is composed of a substrate holder 145, a projection 146, a projection 147, and an opening 148. The memory tag substrate 143 is held with the substrate surface perpendicular to the surface of the opening 148.

The memory tag unit 144 may be made of an insulating material such as a resin so as to prevent a short circuit in the electric circuit including the electrical contacts 121 and the processing circuit 123 on the printed circuit board 122 of the memory tag substrate 143. In the present embodiment, the memory tag unit 144 is configured such that the substrate holder 145 composed of two independent parts is fixed while sandwiching the memory tag substrate 143, but is not limited to such a configuration. For example, it is also acceptable to adopt a configuration in which the memory tag substrate 143 is inserted into and fixed to a single substrate holder 145, or any other suitable configuration may be employed.

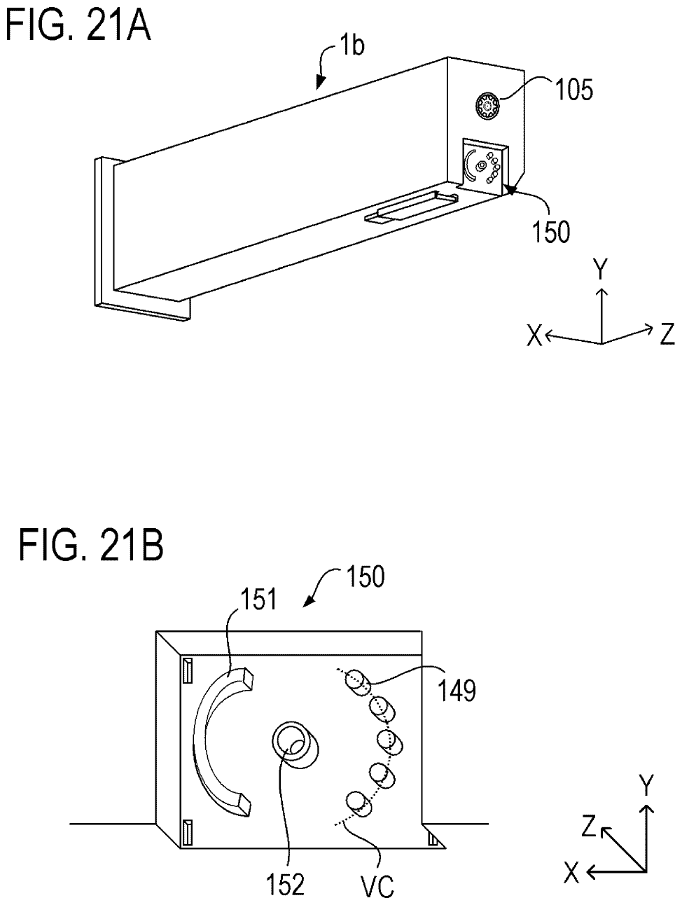

FIG. 21A is a perspective view of the toner cartridge 1b from the lower rear side to clearly show the memory tag space 150 for arranging the memory tag in the toner cartridge 1b. FIG. 21B is a perspective view showing an enlarged view of the memory tag space 150 and its vicinity. The memory tag space 150 as an attachment portion is composed of a plurality of projections 149 arranged at intervals, a cylindrical projection 152 into which the projection 146 of the memory tag unit 144 is inserted, and a base 151 that supports the memory tag unit 144.

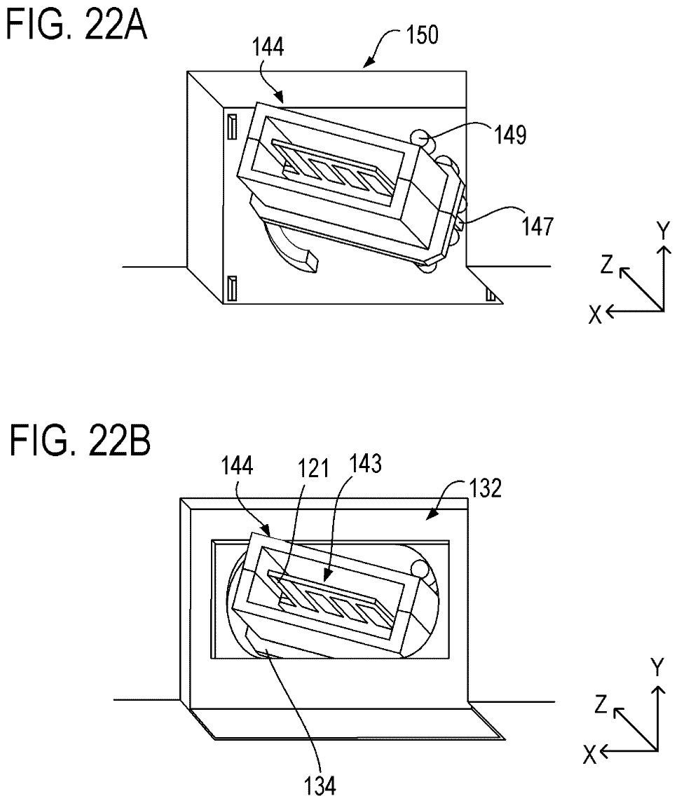

FIG. 22A is a perspective view showing the memory tag unit 144 assembled in the memory tag space 150. The memory tag space 150 as an attachment portion to which the memory tag unit 144 is attached has the same shape across all toner cartridges 1b. When the memory tag unit 144 is assembled in the memory tag space 150, the projection 146 (positioned portion) shown in FIGS. 20A and 20B is inserted into the hole (positioning portion) of the cylindrical projection 152, and they engage with each other so as to be rotatable around the rotation axis along the mounting direction of the toner cartridge 1. At the same time, the projection 147 (rotation-restricted portion) is selectively inserted between two adjacent projections 149 among the multiple projections 149 (rotation-restricting portions). The attachment angle of the memory tag unit 144 relative to the memory tag space 150 is determined depending on which two projections 149 the projection 147 is engaged between. In other words, the projection 149 is a rotation stopper that passes through the hole of the projection 146 or the projection 152 and engages with the projection 147 so as to restrict the rotation of the memory tag unit 144 relative to the memory tag space 150 around the rotation axis along the mounting direction. The projections 149 are arranged so that multiple projections are centered around the rotation axis or aligned on a virtual arc VC. This configuration allows the memory tag unit 144 to be selectively attached to the memory tag space 150 at different angles around the rotation axis of the projection 146 relative to the hole in the projection 152, that is, around the rotation axis perpendicular to the XY plane. As a result, the memory tag units 144 have the same shape when viewed in a direction parallel to the mounting direction in each toner cartridge 1b, but can be configured so that the angle at which they are attached to the toner cartridge 1b differs for each color of the toner cartridge 1b.

FIG. 22B is a perspective view showing the state in which the memory tag cover 132 is attached from the state shown in FIG. 22A. Even if the memory tag unit 144 is attached at multiple different angles, a part of the memory tag unit 144 and the memory tag substrate 143 can be seen through the opening 134 of the memory tag cover 132.

Here, the memory tag unit 144 has a floating structure that has a degree of freedom in the relative position that allows the connection state to be formed with respect to the toner cartridge 1b. That is, the diameter of the projection 146 (see FIGS. 20A and 20B) is smaller than the inner diameter of the hole of the cylindrical projection 152, creating a gap that provides the above-mentioned degree of freedom. Also, the width (thickness) of the projection 147 as the rotation-restricted portion may be smaller than the interval between two adjacent projections 149 among the multiple projections 149, creating a gap that provides the above-mentioned degree of freedom. Furthermore, in a state where the memory tag cover 132 shown in FIG. 22B is attached, the dimensions of the memory tag unit 144 relative to the memory tag cover 132 may be determined such that the memory tag unit 144 can move within a predetermined range in the Z direction, allowing for the above-mentioned degree of freedom.

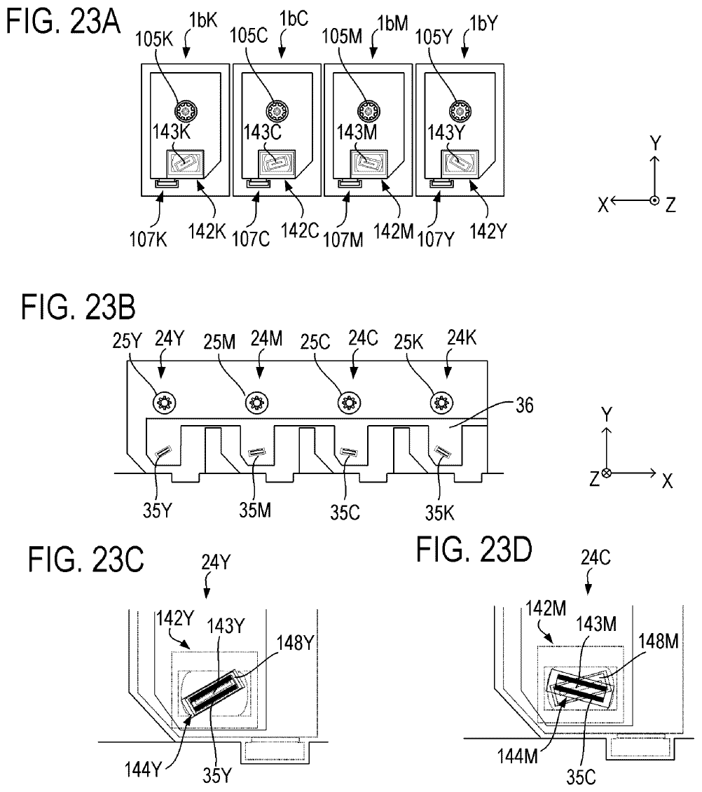

With reference to FIGS. 23A to 23D, a specific mechanism for preventing erroneous mounting of the toner cartridge 1b in the present embodiment will be described.

FIG. 23A is a view of the rear side of the toner cartridge 1b, that is, the side where the coupling 105 of the toner cartridge 1b is arranged, with the first to fourth toner cartridges 1Y to 1K mounted in the apparatus main body 10B. The memory tag substrates 143Y to 143K included in the memory tags 106Y to 106K arranged in the first to fourth toner cartridges 1bY to 1bK are at different angles when viewed in a direction parallel to the mounting direction of the toner cartridge 1b to the apparatus main body 10B. That is, the memory tag substrates 143 are arranged so that the orientations (angles, postures) around the rotation axis extending in a direction (Z direction) perpendicular to the toner discharge direction (−Y direction) in the toner discharge portion 107 are different from each other in the XY plane. The rotation axis at this time is the rotation axis of the projection 146 relative to the hole of the projection 152 shown in FIGS. 20A and 20B.

FIG. 23B is a front view of the first to fourth toner cartridge mounting portions 24Y to 24K, which are positions for mounting the first to fourth toner cartridges 1Y to 1K in the apparatus main body 10B. In the present embodiment, the body-side contact is a connector 35 for engaging with the memory tag substrate 143 of the memory tag 106 to make electrical contact. Here, the first to fourth connectors 35Y to 35K are mounted on a substrate 36 in order to fix the connector 35 to the toner cartridge mounting portion 24. Although FIG. 23B shows a configuration in which multiple connectors 35 are mounted on a single substrate, that is, the substrate 36, a configuration in which the connectors are mounted on multiple independent substrates may also be used. In addition, the connector 35 may be directly held and fixed in the toner cartridge mounting portion 24.

FIG. 23C shows a case where a compatible toner cartridge 1b among four types of toner cartridges 1b is mounted in one of the four toner cartridge mounting portions 24. FIG. 23D shows a case where an incompatible (mismatched) toner cartridge 1b among four types of toner cartridges 1b is inserted (mounted) in one of the four toner cartridge mounting portions 224.

FIG. 23C shows an enlarged view, from the front side, of the state where the first toner cartridge 1bY as a compatible cartridge is properly mounted in the first toner cartridge mounting portion 24Y When the first toner cartridge 1bY is mounted in the first toner cartridge mounting portion 24Y, the connector 35Y can enter the opening 148Y provided in the memory tag 106Y This ensures that the contact between the connector 35Y and the memory tag substrate 143Y of the memory tag 106Y is established.

In contrast, FIG. 23D shows an enlarged view, from the front side, of the state where the second toner cartridge 1bM is mistakenly inserted as an incompatible cartridge into the third toner cartridge mounting portion 24C. When the second toner cartridge 1bM is inserted into the third toner cartridge mounting portion 24C, the connector 35C interferes with the opening 148M (the edge around the opening 148M) provided in the memory tag 106M. As a result, contact between the connector 35C and the memory tag substrate 143M of the memory tag 106M is not established.

When the second toner cartridge 1bM is inserted (mounted) into the third toner cartridge mounting portion 24C, the connection between the connector 35C and the memory tag substrate 143M is not established, so the control portion of the apparatus main body 10B cannot control the second toner cartridge 1bM. As a result, the control portion can detect that an incompatible cartridge has been inserted (mounted) into the third toner cartridge mounting portion 24C, thereby preventing the image forming operation from being performed while the incompatible cartridge remains mounted. In other words, it is possible to prevent the erroneous mounting into the third toner cartridge mounting portion 24C (prompting the user to resolve the erroneous mounting state).

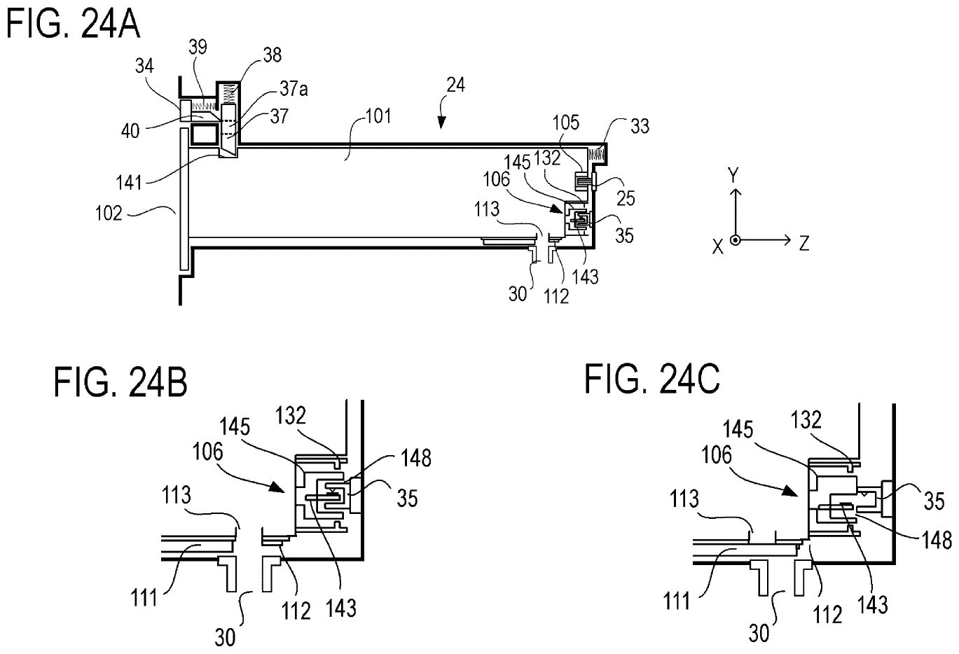

Furthermore, with reference to FIGS. 24A to 24C, a specific mechanism for preventing erroneous mounting of the toner cartridge 1b in the present embodiment will be described. FIGS. 24A to 24C are cross-sectional views of the toner cartridge mounting portion 24 and the toner cartridge 1b in the longitudinal direction. In the second embodiment, the parts that overlap with the contents of the first embodiment described with reference to FIGS. 14A and 14B will be omitted.

FIG. 24A shows a state in which the correct toner cartridge 1b corresponding to the toner cartridge mounting portion 24 is mounted. Furthermore, FIG. 24B is an enlarged view showing the state near the memory tag 106 at that time. The connector 35, which is the body-side contact, fits into the opening 134 of the memory tag cover 132 of the memory tag 106 and the opening 148 of the substrate holder 145 so that the memory tag substrate 143 of the memory tag 106 and the connector 35 are fitted together. As a result, the memory tag 106 and the image forming apparatus 10 can communicate with each other.

At this time, the locking member 37 of the toner cartridge mounting portion 24 is inserted into the recess 141 on the upper surface of the toner cartridge 1b by the biasing force of the spring member 38. In this way, the toner cartridge 1b is locked in the mounted state in the apparatus main body 10B.

When the user presses the toner cartridge removal button 34 in the Z direction, the projection 40 connected to the toner cartridge removal button 34 enters a hollow portion 37a (between the dashed lines) of the locking member 37 against the biasing force of the spring member 39. As a result, the locking member 37 rises in the Y direction against the biasing force of the spring member 38, and the lower part of the locking member 37 comes out of the recess 141. Next, the toner cartridge 1b is pushed out in the −Z direction by the biasing force of the spring member 33 provided in the toner cartridge mounting portion 24. The toner cartridge 1b remains in an unmounted state in the apparatus main body 10B, and is released into an unlocked state.

FIG. 24C is an enlarged view showing the state near the memory tag 106 when an incorrect toner cartridge 1b is inserted (mounted) as an incompatible cartridge into the toner cartridge mounting portion 24. As shown in FIG. 24C, the connector 35 cannot enter the opening 134 of the memory tag cover 132 in the memory tag 106 or the opening 148 of the substrate holder 145 and interferes with it. As a result, the memory tag substrate 143 and the connector 35 cannot be fitted together, and the memory tag 106 and the image forming apparatus 10 cannot communicate with each other.

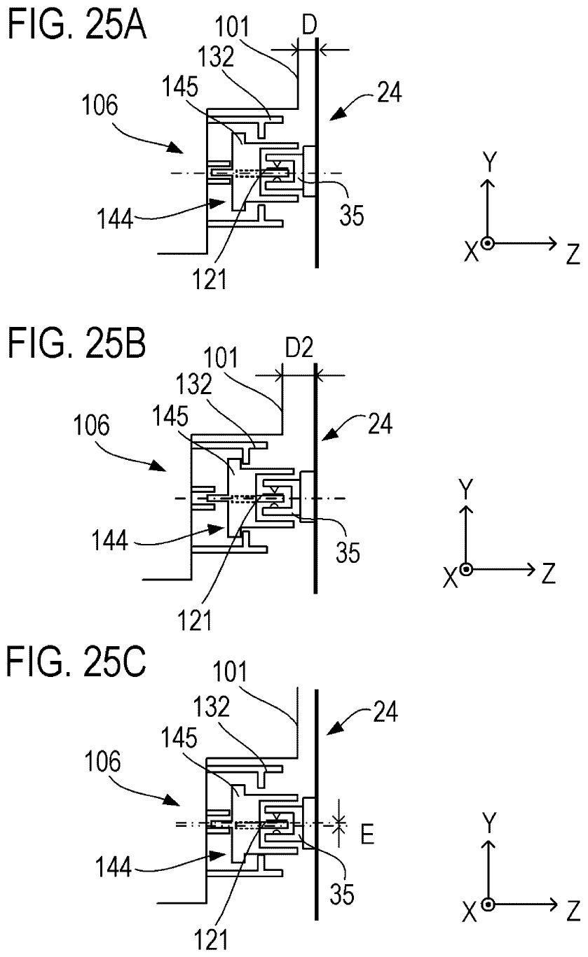

A specific floating structure in the present embodiment will be described with reference to FIGS. 25A to 25C. FIGS. 25A to 25C are enlarged views showing the memory tag unit 144 included in the memory tag 106 and the vicinity of the connector 35 fixed to the toner cartridge mounting portion 24. Here, as shown in FIGS. 25A to 25C, the memory tag unit 144 has a floating structure that allows it to follow the connector 35 fixed to the toner cartridge mounting portion 24 within a predetermined range. That is, in the memory tag unit 144 of the present embodiment, the surface of the electrical contact 121 (cartridge contact surface) has a normal direction intersecting (orthogonal in the present embodiment, though not limited thereto) the mounting direction of the toner cartridge 1 to the apparatus main body 10B. In addition, the direction in which each surface (each cartridge contact surface) of the multiple electrical contacts 121 is aligned also intersects (orthogonal in the present embodiment, though not limited thereto) the mounting direction. The alignment direction of the cartridge contact surface differs depending on the color of the toner cartridge 1.

FIG. 25A shows a state in which the electrical contact 121 of the memory tag unit 144 and the connector 35 are in contact at positions defined by the design tolerance specifications. At this time, the distance in the Z direction between the replenishment container 101 and the toner cartridge mounting portion 24 of the toner cartridge 1b at a representative position is defined as D.

FIG. 25B shows a state in which the replenishment container 101 and the toner cartridge mounting portion 24 are separated from each other, and the distance in the Z direction is D2 (>D). The memory tag unit 144 moves in the Z direction inside of the memory tag cover 132, thereby maintaining contact between the electrical contact 121 and the connector 35.

FIG. 25C shows a state in which the replenishment container 101 is shifted by a distance E in the Y direction relative to the toner cartridge mounting portion 24. The memory tag unit 144 moves in the Y direction inside of the memory tag cover 132, thereby maintaining contact between the electrical contact 121 and the connector 35.

Here, representative positional deviations in the Z direction and Y direction have been illustrated, but it is desirable to have a floating structure that can follow positional deviations in other directions as well. In addition, the floating structure in which a degree of freedom in position is provided by the movement of the memory tag unit 144 has been described. However, a floating structure may be alternatively employed in which the connector 35 has a degree of freedom in position with respect to the toner cartridge mounting portion 24.

### Effects of Present Embodiment

As described above, the following effects can be obtained by using the image forming apparatus 10 and toner cartridge 1b according to the present embodiment.

Even in a configuration in which the substrate holder 145 of the memory tag 106 is arranged vertically in the Z direction and is fitted with the connector 35 on the apparatus main body 10B side, the angle of the substrate holder 145 and the corresponding angle of the connector 35 are configured so as to differ for each color in the XY plane, thereby reliably preventing erroneous mounting of toner cartridges 1b of different colors.

Furthermore, in the first to fourth toner cartridges 1bY to 1bK, the substrate holders 145 of the memory tags 106, which have the same configuration and shape, are attached to the toner cartridge 1b at different angles for each color. That is, in the first to fourth toner cartridges 1bY to 1bK, the substrate holder 145 and the memory tag cover 132 can be commonly used as components having the same shape, molded using the same mold. This is, therefore, effective in reducing the cost of manufacturing parts.

By arranging the substrate holder 145 vertically in the Z direction, it is possible to make the memory tag space 150 at the rear surface of the toner cartridge 1 relatively small compared to the configuration of the first embodiment. Furthermore, since the substrate holder 145 is surrounded by the substrate holder 145, the protection of the memory tag 106 is strengthened.

The above-described embodiments can be combined with each other.

According to the present disclosure, the function of preventing erroneous mounting of a toner cartridge can be realized in a small space, and erroneous mounting can be reliably prevented without reducing the capacity of the toner cartridge as much as possible.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-088069, filed on May 30, 2024, which is hereby incorporated by reference herein in its entirety.

What is claimed is:

1. An image forming apparatus that forms a toner image on a recording material, comprising:
an apparatus main body, the apparatus main body including a first photosensitive drum having a first direction as a longitudinal direction, a second photosensitive drum having the first direction as the longitudinal direction, a first developing unit having a first developing roller that supplies toner to the first photosensitive drum and a first toner storage portion that stores toner to be borne by the first developing roller, and a second developing unit having a second developing roller that supplies toner to the second photosensitive drum and a second toner storage portion that stores toner to be borne by the second developing roller;
a first toner cartridge for replenishing toner to the first developing unit, the first toner cartridge having a first container for storing toner, and being mountable in a mounting direction that is a direction along the first direction with respect to the apparatus main body; and
a second toner cartridge for replenishing toner to the second developing unit, the second toner cartridge having a second container for storing toner, and being mountable in the mounting direction with respect to the apparatus main body,
wherein the first toner cartridge has a first memory unit including a first electric substrate provided with a first cartridge contact surface and a first attachment portion to which the first electric substrate is attached,
wherein the second toner cartridge has a second memory unit including a second electric substrate provided with a second cartridge contact surface and a second attachment portion to which the second electric substrate is attached,
wherein the apparatus main body has a first mounting portion for mounting the first toner cartridge and a second mounting portion for mounting the second toner cartridge, the first mounting portion being provided with a first terminal that electrically contacts the first cartridge contact surface, and the second mounting portion being provided with a second terminal that electrically contacts the second cartridge contact surface, and
wherein, in a case of being viewed in a direction parallel to the mounting direction, the first electric substrate has the same shape as the second electric substrate, the first attachment portion has the same shape as the second attachment portion and an angle at which the first electric substrate is attached to the first attachment portion is different from an angle at which the second electric substrate is attached to the second attachment portion.

2. The image forming apparatus according to claim 1,
wherein a normal direction of the first cartridge contact surface of the first electric substrate and a normal direction of the second cartridge contact surface of the second electric substrate are both directions intersecting the mounting direction.

3. The image forming apparatus according to claim 1,
wherein a normal direction of the first cartridge contact surface of the first electric substrate and a normal direction of the second cartridge contact surface of the second electric substrate are both in the mounting direction.

4. The image forming apparatus according to claim 2,
wherein a first discharge port provided in the first container to discharge toner from the first container to replenish toner to the first toner storage portion of the first developing unit and a second discharge port provided in the second container to discharge toner from the second container to replenish toner to the second toner storage portion of the second developing unit are open in a direction intersecting the mounting direction.

5. The image forming apparatus according to claim 3,
wherein a first discharge port provided in the first container to discharge toner from the first container to replenish toner to the first toner storage portion of the first developing unit and a second discharge port provided in the second container to discharge toner from the second container to replenish toner to the second toner storage portion of the second developing unit are open in a direction intersecting the mounting direction.

6. The image forming apparatus according to claim 4,
wherein the apparatus main body has a first driving member and a second driving member,
wherein the first toner cartridge has a first conveying member for conveying toner toward the first discharge port inside of the first container and a first driving force receiving member that engages with the first driving member so as to receive a driving force for driving the first conveying member from the first driving member, the first driving force receiving member rotating around a first rotation axis extending in the mounting direction,
wherein the second toner cartridge has a second conveying member for conveying toner toward the second discharge port inside of the second container and a second driving force receiving member that engages with the second driving member so as to receive a driving force for driving the second conveying member from the second driving member, the second driving force receiving member rotating around a second rotation axis extending in the mounting direction,
wherein, in a case of being viewed in a direction parallel to the mounting direction, at least a portion of the first electric substrate is disposed above the first discharge port and below the first rotation axis, and
wherein, in a case of being viewed in a direction parallel to the mounting direction, at least a portion of the second electric substrate is disposed above the second discharge port and below the second rotation axis.

7. The image forming apparatus according to claim 4,
wherein, in a case of being viewed in a direction parallel to the mounting direction, the first electric substrate is disposed above the first discharge port, and
wherein, in a case of being viewed in a direction parallel to the mounting direction, the second electric substrate is disposed above the second discharge port.

8. The image forming apparatus according to claim 5,
wherein the apparatus main body has a first driving member and a second driving member,
wherein the first toner cartridge has a first conveying member for conveying toner toward the first discharge port inside of the first container and a first driving force receiving member that engages with the first driving member so as to receive a driving force for driving the first conveying member from the first driving member, the first driving force receiving member rotating around a first rotation axis extending in the mounting direction,
wherein the second toner cartridge has a second conveying member for conveying toner toward the second discharge port inside of the second container and a second driving force receiving member that engages with the second driving member so as to receive a driving force for driving the second conveying member from the second driving member, the second driving force receiving member rotating around a second rotation axis extending in the mounting direction,
wherein, in a case of being viewed in a direction parallel to the mounting direction, at least a part of the first electric substrate is disposed above the first discharge port and below the first rotation axis, and
wherein, in a case of being viewed in a direction parallel to the mounting direction, at least a part of the second electric substrate is disposed above the second discharge port and below the second rotation axis.

9. The image forming apparatus according to claim 5,
wherein, in a case of being viewed in a direction parallel to the mounting direction, the first electric substrate is disposed above the first discharge port, and wherein, in a case of being viewed in a direction parallel to the mounting direction, the second electric substrate is disposed above the second discharge port.

10. The image forming apparatus according to claim 4,
wherein, in the mounting direction, the first electric substrate is disposed downstream of the first discharge port, and
wherein, in the mounting direction, the second electric substrate is disposed downstream of the second discharge port.

11. The image forming apparatus according to claim 5,
wherein, in the mounting direction, the first electric substrate is provided downstream of the first discharge port, and
wherein, in the mounting direction, the second electric substrate is provided downstream of the second discharge port.

12. The image forming apparatus according to claim 1,
wherein the first toner cartridge has a first contact holder arranged to surround a periphery of the first cartridge contact surface of the first electric substrate in a case of being viewed in a direction parallel to the mounting direction and located downstream in the mounting direction,
wherein the second toner cartridge has a second contact holder arranged to surround a periphery of the second cartridge contact surface of the second electric substrate in a case of being viewed in the direction parallel to the mounting direction and located downstream in the mounting direction, and
wherein, in a case of being viewed in the direction parallel to the mounting direction, the first contact holder has the same shape as the second contact holder, and an angle at which the first contact holder is attached to the first attachment portion is different from an angle at which the second contact holder is attached to the second attachment portion.

13. The image forming apparatus according to claim 12,
wherein the first mounting portion has a first terminal holder arranged to surround the first terminal in a case of being viewed in the mounting direction,
wherein the second mounting portion has a second terminal holder arranged to surround the second terminal in a case of being viewed in the mounting direction,
wherein, in a case where the first toner cartridge is moved in the mounting direction in the second mounting portion, the first contact holder of the first toner cartridge interferes with the second terminal holder so that the first toner cartridge cannot be mounted in the second mounting portion, and
wherein, in a case where the second toner cartridge is moved in the mounting direction in the first mounting portion, the second contact holder of the second toner cartridge interferes with the first terminal holder so that the second toner cartridge cannot be mounted in the first mounting portion.

14. The image forming apparatus according to claim 13,
wherein the first mounting portion includes:
a first biasing member that biases the first toner cartridge at a first mounting position in the first mounting portion toward an upstream side in the mounting direction; and
a first restricting member that can take a first restricting position at which movement of the first toner cartridge at the first mounting position from moving toward the upstream side in the mounting direction is restricted and a first non-restricting position at which the movement is not restricted,
wherein the second mounting portion includes:
a second biasing member that biases the second toner cartridge at a second mounting position in the second mounting portion toward the upstream side in the mounting direction; and
a second restricting member that can take a second restricting position at which movement of the second toner cartridge at the second mounting position from moving toward the upstream side in the mounting direction is restricted and a second non-restricting position at which the movement is not restricted;
wherein the first toner cartridge is configured such that the first toner cartridge cannot reach the second mounting position due to interference between the first contact holder and the second terminal holder in the second mounting portion, and
wherein the second toner cartridge is configured such that the second toner cartridge cannot reach the first mounting position due to interference between the second contact holder and the first terminal holder in the first mounting portion.

15. The image forming apparatus according to claim 14,
wherein the first restricting member is configured such that the first restricting member cannot move to the first restricting position in a case where the second toner cartridge is in the first mounting portion, and
wherein the second restricting member is configured such that the second restricting member cannot move to the second restricting position in a case where the first toner cartridge is in the second mounting portion.

16. The image forming apparatus according to claim 12,
wherein the first contact holder has a first positioned portion and a first rotation-restricted portion,
wherein the first attachment portion has a first positioning portion that engages with the first positioned portion and a first rotation-restricting portion that engages with the first rotation-restricted portion so as to restrict rotation of the first contact holder relative to the first attachment portion around a first rotation axis that passes through the first positioning portion and is along the mounting direction,
wherein a plurality of the first rotation-restricting portions is arranged in a line on a virtual circle centered around the first rotation axis,
wherein the first rotation-restricted portion is configured to be capable of selectively engaging with one of the plurality of the first rotation-restricting portions,
wherein the first positioned portion of the first contact holder engages with the first positioning portion of the first attachment portion, and the first rotation-restricted portion of the first contact holder engages with one of the plurality of the first rotation-restricting portions of the first attachment portion, thereby determining an attachment angle of the first electric substrate relative to the first attachment portion,
wherein the second contact holder has a second positioned portion and a second rotation-restricted portion,
wherein the second attachment portion has a second positioning portion that engages with the second positioned portion and a second rotation-restricting portion that engages with the second rotation-restricted portion so as to restrict rotation of the second contact holder relative to the second attachment portion centered around a second rotation axis that passes through the second positioning portion and is along the mounting direction,
wherein a plurality of the second rotation-restricting portions is arranged in a line on an arc centered around the second rotation axis,
wherein the second rotation-restricted portion is configured to be capable of selectively engaging with one of the plurality of the first rotation-restricting portions, and
wherein the second positioned portion of the second contact holder engages with the second positioning portion of the second attachment portion, and the second rotation-restricted portion of the second contact holder engages with one of the plurality of the second rotation-restricting portions of the second attachment portion, thereby determining an attachment angle of the second electric substrate with respect to the second attachment portion.

17. The image forming apparatus according to claim 16,
wherein a plurality of the first cartridge contact surface is provided,
wherein the plurality of the first cartridge contact surfaces includes a contact surface for transmitting a power supply voltage to the first memory unit, a contact surface for transmitting a clock signal to the first memory unit, a contact surface for transmitting data to the first memory unit, and a contact surface for installing the first memory unit, aligned in this order in a direction intersecting the direction in which the first rotation axis extends,
wherein a plurality of the second cartridge contact surfaces is provided, and
wherein the plurality of the second cartridge contact surfaces is provided so as to be arranged in a direction intersecting the direction in which the second rotation axis extends, and include a contact surface for transmitting a power supply voltage to the second memory unit, a contact surface for transmitting a clock signal to the second memory unit, a contact surface for transmitting data to the second memory unit, and a contact surface for installing the second memory unit, aligned in this order in a direction intersecting the direction in which the second rotation axis extends.

18. An image forming apparatus that forms a toner image on a recording material comprising:
an apparatus main body, the apparatus main body including a first photosensitive drum having a first direction as a longitudinal direction, a second photosensitive drum having the first direction as the longitudinal direction, a first developing unit having a first developing roller that supplies toner to the first photosensitive drum and a first toner storage portion that stores toner to be borne by the first developing roller, and a second developing unit having a second developing roller that supplies toner to the second photosensitive drum and a second toner storage portion that stores toner to be borne by the second developing roller;
a first toner cartridge for replenishing toner to the first developing unit, the first toner cartridge having a first container for storing toner, and being mountable in a mounting direction that is a direction along the first direction with respect to the apparatus main body; and
a second toner cartridge for replenishing toner to the second developing unit, the second toner cartridge having a second container for storing toner, and being mountable in the mounting direction with respect to the apparatus main body,
wherein the first toner cartridge has a first memory unit including a first electric substrate on which a first cartridge contact surface is provided,
wherein the second toner cartridge has a second memory unit including a second electric substrate on which a second cartridge contact surface is provided,
wherein the apparatus main body has a first mounting portion for mounting the first toner cartridge and a second mounting portion for mounting the second toner cartridge, the first mounting portion being provided with a first terminal that electrically contacts the first cartridge contact surface, and the second mounting portion being provided with a second terminal that electrically contacts the second cartridge contact surface, and
wherein a normal direction of the first cartridge contact surface of the first electric substrate and a normal direction of the second cartridge contact surface of the second electric substrate both intersect the mounting direction and are different from each other.

19. An image forming apparatus that forms a toner image on a recording material comprising:
an apparatus main body, the apparatus main body including a first photosensitive drum having a first direction as a longitudinal direction, a second photosensitive drum having the first direction as the longitudinal direction, a first developing unit having a first developing roller that supplies toner to the first photosensitive drum and a first toner storage portion that stores toner to be borne by the first developing roller, and a second developing unit having a second developing roller that supplies toner to the second photosensitive drum and a second toner storage portion that stores toner to be borne by the second developing roller;
a first toner cartridge for replenishing toner to the first developing unit, the first toner cartridge having a first container for storing toner, and being mountable in a mounting direction that is a direction along the first direction with respect to the apparatus main body; and
a second toner cartridge for replenishing toner to the second developing unit, the second toner cartridge having a second container for storing toner, and being mountable in the mounting direction with respect to the apparatus main body,
wherein the first toner cartridge has a first memory unit including a first electric substrate on which a plurality of first cartridge contact surfaces is provided and a normal direction of the first cartridge contact surfaces is the mounting direction,
wherein the second toner cartridge has a second memory unit including a second electric substrate on which a plurality of second cartridge contact surfaces is provided and a normal direction of the second cartridge contact surfaces is the mounting direction,
wherein the apparatus main body has a first mounting portion for mounting the first toner cartridge and a second mounting portion for mounting the second toner cartridge, the first mounting portion being provided with a first terminal that electrically contacts the first cartridge contact surfaces, and the second mounting portion being provided with a second terminal that electrically contacts the second cartridge contact surfaces, and
wherein, in a case of being viewed in a direction parallel to the mounting direction, a direction in which the plurality of the first cartridge contact surfaces is aligned is different from a direction in which the plurality of the second cartridge contact surfaces is aligned.

20. An image forming apparatus that forms a toner image on a recording material comprising:
an apparatus main body, the apparatus main body including a first photosensitive drum having a first direction as a longitudinal direction, a second photosensitive drum having the first direction as the longitudinal direction, a first developing unit having a first developing roller that supplies toner to the first photosensitive drum and a first toner storage portion that stores toner to be borne by the first developing roller, and a second developing unit having a second developing roller that supplies toner to the second photosensitive drum and a second toner storage portion that stores toner to be borne by the second developing roller;
a first toner cartridge for replenishing toner to the first developing unit, the first toner cartridge having a first container for storing toner, and being mountable in a mounting direction that is a direction along the first direction with respect to the apparatus main body; and
a second toner cartridge for replenishing toner to the second developing unit, the second toner cartridge having a second container for storing toner, and being mountable in the mounting direction with respect to the apparatus main body,
wherein the first toner cartridge has a first memory unit including a first electric substrate provided with a first cartridge contact surface, a first agitation member for agitating the toner inside of the first container, and a first driving force receiving member for receiving a driving force for driving the first agitation member, the first driving force receiving member rotating around a first rotation axis extending in the mounting direction,
wherein the second toner cartridge has a second memory unit including a second electric substrate provided with a second cartridge contact surface, a second agitation member for agitating the toner inside of the second container, and a second driving force receiving member for receiving a driving force for driving the second agitation member, the second driving force receiving member rotating around a second rotation axis extending in the mounting direction,
wherein the apparatus main body has a first mounting portion for mounting the first toner cartridge, a second mounting portion for mounting the second toner cartridge, a first driving member that engages with the first driving force receiving member to transmit a driving force to the first driving force receiving member, and a second driving member that engages with the second driving force receiving member to transmit a driving force to the second driving force receiving member, the first mounting portion being provided with a first terminal that electrically contacts the first cartridge contact surface, and the second mounting portion being provided with a second terminal that electrically contacts the second cartridge contact surface, and
wherein, in a case of being viewed in a direction parallel to the mounting direction, coordinates of the first electric substrate in a two-dimensional first coordinate system composed of a first virtual line that passes through the first rotation axis as its origin and extends in a horizontal direction, and a second virtual line that passes through the first rotation axis and extends in a gravitational direction, and coordinates of the second electric substrate in a two-dimensional second coordinate system composed of a third virtual line that passes through the second rotation axis as its origin and extends in the horizontal direction, and a fourth virtual line that passes through the second rotation axis and extends in the gravitational direction, have different regions in a case where the first coordinate system and the second coordinate system are superimposed so that their respective origins coincide.

21. A cartridge set comprising:
a first toner cartridge; and
a second toner cartridge;
the first toner cartridge includes:
a first container for storing a first toner, the first container having a first direction as a longitudinal direction, and having a first discharge port that opens in a direction intersecting the first direction so as to discharge the first toner from the first container; and
a first memory unit provided on a first attachment portion on an end surface of the first container in the first direction, the first memory unit including a first electric substrate having a first cartridge contact surface,
the second toner cartridge includes:
a second container for storing a second toner having a color different from that of the first toner, the second container having a second direction as a longitudinal direction, and having a second discharge port that opens in a direction intersecting the second direction so as to discharge the second toner from the second container; and
a second memory unit provided on a second attachment portion on an end surface of the second container in the second direction, the second memory unit including a second electric substrate having a second cartridge contact surface,
wherein the first attachment portion and the first electric substrate in a case of being viewed in the first direction have the same shape as the second attachment portion and the second electric substrate in a case of being viewed in the second direction, and
wherein an attachment angle of the first electric substrate relative to the first attachment portion in a case of being viewed in the first direction is different from an attachment angle of the second electric substrate relative to the second attachment portion in a case of being viewed in the second direction.

22. A cartridge set comprising:
a first toner cartridge detachably attached to an apparatus main body of an image forming apparatus; and
a second toner cartridge detachably attached to the apparatus main body;
the first toner cartridge includes:
a first container for storing a first toner, the first container having a first direction as a longitudinal direction, and having a first discharge port that opens in a direction intersecting the first direction so as to discharge the first toner from the first container; and
a first memory unit provided on a first end surface which is an end surface of the first container in the first direction and including a first electric substrate on which a first cartridge contact surface is provided;
the second toner cartridge includes:
a second container for storing a second toner having a color different from that of the first toner, the second container having a second direction as a longitudinal direction, and having a second discharge port that opens in a direction intersecting the second direction so as to discharge the second toner from the second container; and
a second memory unit provided on a second end surface which is an end surface of the second container in the second direction and including a second electric substrate on which a second cartridge contact surface is provided,
wherein, in a state where the first toner cartridge and the second toner cartridge are mounted in the apparatus main body such that the first direction and the second direction are parallel, a normal direction of the first cartridge contact surface of the first electric substrate and a normal direction of the second cartridge contact surface of the second electric substrate both intersect the first direction and the second direction and are different from each other.

23. A cartridge set comprising:
a first toner cartridge detachably attached to an apparatus main body of an image forming apparatus; and
a second toner cartridge detachably attached to the apparatus main body;
the first toner cartridge includes:
a first container for storing a first toner, the first container having a first direction as a longitudinal direction, and having a first discharge port that opens in a direction intersecting the first direction so as to discharge the first toner from the first container; and
a first memory unit provided on a first end surface which is an end surface of the first container in the first direction and including a first electric substrate on which a plurality of first cartridge contact surfaces is provided;
the second toner cartridge includes:
a second container for storing a second toner having a color different from that of the first toner, the second container having the second direction as a longitudinal direction and having a second discharge port that opens in a direction intersecting the second direction so as to discharge the second toner from the second container; and
a second memory unit provided on a second end surface which is an end surface of the second container in the second direction and having a second electric substrate on which a plurality of second cartridge contact surfaces is provided,
wherein, in a state where the first toner cartridge and the second toner cartridge are mounted in the apparatus main body such that the first direction and the second direction are parallel, a direction in which the plurality of the first cartridge contact surfaces is aligned in a case of being viewed in the first direction is different from a direction in which the plurality of the second cartridge contact surfaces is aligned in a case of being viewed in the second direction.

24. A cartridge set comprising:
a first toner cartridge detachably attached to an apparatus main body of an image forming apparatus; and
a second toner cartridge detachably attached to the apparatus main body;
the first toner cartridge includes:
a first container for storing a first toner, the first container having a first direction as a longitudinal direction, and having a first discharge port that opens in a direction intersecting the first direction so as to discharge the first toner from the first container;
a first memory unit provided on a first end surface which is an end surface of the first container in the first direction and including a first electric substrate on which a first cartridge contact surface is provided; and
a first agitation member for agitating toner inside of the first container; and a first driving force receiving member for receiving a driving force for driving the first agitation member, the first driving force receiving member rotating around a first rotation axis extending in the first direction,
the second toner cartridge includes:
a second container for storing a second toner having a color different from that of the first toner, the second container having the second direction as a longitudinal direction and having a second discharge port that opens in a direction intersecting the second direction and for discharging the second toner from the second container;
a second memory unit provided on a second end surface which is an end surface of the second container in the second direction and including a second electric substrate on which a second cartridge contact surface is provided; and
a second agitation member for agitating toner inside of the second container; and a second driving force receiving member for receiving a driving force for driving the second agitation member, the second driving force receiving member rotating around a second rotation axis extending in the second direction;
wherein, in a state where the first toner cartridge and the second toner cartridge are mounted in the apparatus main body so that the first direction and the second direction are parallel,
wherein coordinates of the first electric substrate in a two-dimensional first coordinate system composed of a first virtual line that passes through the first rotation axis as its origin and extends in a horizontal direction, and a second virtual line that passes through the first rotation axis and extends in a gravitational direction in a case of being viewed in the first direction, and coordinates of the second electric substrate in a two-dimensional second coordinate system composed of a third virtual line that passes through the second rotation axis as its origin and extends in the horizontal direction, and a fourth virtual line that passes through the second rotation axis and extends in the gravitational direction in a case of being viewed in the second direction have different regions in a case where the first coordinate system and the second coordinate system are superimposed so that their respective origins coincide.
